(19) United States
(12) Patent Application Publication
(10) Pub. No.: US 2026/0330400 A1
(43) Pub. Date: Oct. 22, 2026

(54) ARTIFICIAL INTELLIGENCE (AI) VIRTUAL DESKTOP (VD) SYSTEM, METHOD AND PROGRAM PRODUCT FOR MANAGING OCCUPATIONAL NETWORKS

(71) Applicant: Michael Nonahal, Stanton, CA (US)

(72) Inventor: Michael Nonahal, Stanton, CA (US)

(21) Appl. No.: 19/185,071

(22) Filed: Apr. 21, 2025

(51) Int. Cl. G06Q 30/0601; G06F 9/451; G06Q 10/087

(52) U.S. Cl. CPC G06Q 10/087; G06F 9/452

(57) ABSTRACT

A software program product including an artificial intelligence (AI) virtual desktop (VD) software code for guiding a user based on a predefined industry or profession; an AI VD graphical user interface (GUI) software code for visually presenting the predefined industry or profession; a security camera software code for tracking or identifying at least one of supplies and equipment; an AI engine software code for learning personal interaction or transactions and assists in making business and/or personal decisions; a payment gateway software code for generating redistributions based upon financial transactions and/or processing financial transactions; an image recognition software code for identifying similar items and consolidate the items into a bulk purchase or tracking in-office behavior and updating a performance dashboard; and a user role/profession software code for determining a configuration of an artificial intelligence (AI) virtual desktop (VD) based on a user role.

### CROSS-REFERENCE TO RELATED APPLICATIONS

Not applicable.

### RELATED CO-PENDING U.S. PATENT APPLICATIONS

The following related U.S. patent application(s), submitted by at least one of the present Applicant(s)/Inventor(s) is/(are) recently co-pending: U.S. utility patent application Ser. No. 18/929,882, entitled “A SYSTEM, METHOD AND COMPUTER PROGRAM PRODUCT FOR GENERATING AI BASED RESUME”, submitted to the United States Patent and Trademark Office (USPTO) on Oct. 29, 2024.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to virtual desktops (VD), computer operating system (OP) or mobile operating system (MOS). More particularly, certain embodiments of the invention relate to artificial intelligence virtual desktop, OP or MOS infrastructures.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that it is a well-known fact that many individuals lack business skills simply because most educational institution curricula are void of any meaningful business training/education. Despite this, professionals, upon graduation, may be unfairly expected to perform and compete against business opponents, in commerce, who may have advanced degree(s) or training in business management. The fact remains that many individuals may lack the necessary business skills which is not limited to access to certain business resources to compete or survive in the business arena. This fact, the staggering student loans, being overcharged by every middle man supply service provider realistically is not an attractive starting point for a business owner or an individual and it is almost impossible for any professional to succeed given those particular challenges. Typically, the global professional communities lose significant economic efficiencies to middle man suppliers who greatly reduce the profitability of those affected working occupations/professionals automatic redistribution. The fact remains that the current system makes it extremely difficult for any profession to successfully manage and operate an efficient business or navigate through life.

One of the major shortcomings in dental education may be the lack of business training which is not limited to sourcing certain business contacts. Many dental professionals struggle to efficiently manage and expand their personal lives, practices, hindering financial success and professional advancement. The lack of standardization in global dental care may have resulted in disparities in treatment quality, safety, and efficiency. Currently, no corporate entity has successfully created an interconnected network exclusively for dental professionals. Most existing digital platforms are costly, fragmented, and lack the comprehensive AI integration. Generally, there is currently no other reliable mechanism by which institutions may generate value from their students or individuals who graduated from their school.

Traditional internet-based systems may operate across generalized data pools where professional, commercial, and AI-driven activities intermingle. This unstructured environment may result in inefficiencies due to high signal-to-noise ratios, irrelevant data flows, and increased latency. There may be a growing need for domain-specific digital ecosystems that reflect the segmentation found in real-world industries.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of an exemplary global profession-based network infrastructure, in accordance with an embodiment of the present invention;

FIG. 2 is an illustration of an exemplary AI-based virtual desktop showing a digital mall graphical user interface (GUI), in accordance with an embodiment of the present invention;

FIG. 3 is an illustration of an exemplary network using at least an API Gateway module as a service, in accordance with an embodiment of the present invention;

FIG. 4 is an illustration of an exemplary global registration flowchart, in accordance with an embodiment of the present invention;

FIG. 5A is an illustration of an exemplary dental AI VD GUI for registration, in accordance with an embodiment of the present invention;

FIG. 5B is an illustration of an exemplary student registration GUI 500B, in accordance with an embodiment of the present invention;

FIG. 6 is an illustration of an exemplary registration process flowchart 600, in accordance with an embodiment of the present invention;

FIG. 7 is an illustration of an exemplary access flowchart by professional group, in accordance with an embodiment of the present invention;

FIG. 8 is an illustration of an exemplary GUI depicting categories of vendors and tools, in accordance with an embodiment of the present invention;

FIG. 9 is an illustration of an exemplary financial flowchart, in accordance with an embodiment of the present invention;

FIG. 10A is an illustration of an exemplary dental network software modules 1000A, in accordance with an embodiment of the present invention;

FIG. 10B is an illustration of an exemplary dental network modules, in accordance with an embodiment of the present invention.

FIG. 11 is an illustration of an exemplary dental supply purchasing process flowchart, in accordance with an embodiment of the present invention;

FIG. 12 is an illustration of an exemplary dental workflow process flowchart, in accordance with an embodiment of the present invention;

FIG. 13 is a block diagram depicting an exemplary client/server system which may be used by an exemplary web-enabled/networked embodiment of the present invention; and

FIG. 14 illustrates a block diagram depicting an exemplary client/server communication system, which may be used by a web-enabled/networked embodiment of the present invention;

FIG. 15 is an illustration of an exemplary flowchart depicting a multi-level automatic redistribution process, in accordance with an embodiment of the present invention;

FIG. 16 is an illustration of an exemplary AI-Driven Virtual Operating System Forming Global Occupational Networks flowchart, in accordance with an embodiment of the present invention; and

FIG. 17 is an illustration of an exemplary flowchart depicting an method for forming an API request for a virtual desktop application, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [” substantially “] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearward most point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, are generally intended to mean late-stage user(s) as opposed to early-stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them-Such terms are open-ended and mean “including but not limited to”. When employed in the appended claims, this term does not foreclose additional structure or steps. Consider a claim that recites: “A memory controller comprising a system cache . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform (ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement a the operation, etc. Reciting that mechanism/unit/circuit/component is “configured to” or “operable for” perform(ing) one or more tasks is expressly intended not to invoke 35 U.S.C. sctn. 112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus, in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components is described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that may be capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks may be performed by local and remote processing devices that may be linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein may be implemented in an operating environment comprising computer-executable instructions (e.g., software) installed on a computer, and mobile phone, cloud based in hardware, or in a combination of software and hardware. The computer-executable instructions may be written in a computer programming language or may be embodied in firmware logic. If written in a programming language conforming to a recognized standard, such instructions may be executed on a variety of hardware platforms and for interfaces to a variety of operating systems. Although not limited thereto, computer software program code for carrying out operations for aspects of the present invention may be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Python, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network may be a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet may be a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer may read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases may be described, it will be understood by one of ordinary skill in the art that (i) alternative database structures to those described may be readily employed, (ii) other memory structures besides databases may be readily employed. Any schematic illustrations and accompanying descriptions of any sample databases presented herein may be exemplary arrangements for stored representations of information. Any number of other arrangements may be employed besides those suggested by the tables shown. Similarly, any illustrated entries of the databases represent exemplary information only; those skilled in the art will understand that the number and content of the entries may be different from those illustrated herein. Further, despite any depiction of the databases as tables, an object-based model could be used to store and manipulate the data types of the present invention and likewise, object methods or behaviors may be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Chrome, Edge, Internet Explorer, Safari, FireFox, or the like), but should be broadly construed to refer to any client-side rendering engine that may access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and may be merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” may include generic structure (e.g., generic circuitry) that may be manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that may be adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media may be any available media that may be accessed by a general purpose or special purpose computer, including the functional design of any special purpose processor as discussed above. By way of example, and not limitation, such non-transitory computer-readable media may include RAM, ROM, EEPROM, CD-ROM or other optical disk storage, magnetic disk storage or other magnetic storage devices, or any other medium which may be used to carry or store desired program code means in the form of computer-executable instructions, data structures, or processor chip design. When information may be transferred or provided over a network or another communications connection (e.g. either hardwired, wireless, or combination thereof) to a computer or cloud-based, the computer properly views the connection as a computer-readable medium. Thus, any such connection may be properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor-based memory, phase change memory, optical memory, periodically refreshed memory, and the like; the non-transitory computer readable medium, however, does not include a pure transitory signal per se; i.e., where the medium itself may be transitory.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Some embodiments of the present invention and variations thereof, relate to artificial intelligence (AI) driven virtual desktop (VD) infrastructure or computer or mobile operating system. In one embodiment of the present invention, an occupational transaction management strategy through the use of the present AI software technology is provided. For example, without limitation, an automatic redistribution system, according to embodiments of the present invention, may enable schools, occupational programs and organizations to automatically track student, alumni and organization members transaction activity and automatically generate redistributions based on their interactions and transactions in real time and throughout the course of their entire lives using the present AI software infrastructure.

To incentivize the use of the AI software product by the end user, the software may have many methods. One example, without limitation, of one type of incentive would be to have the AI software act as an industry specific educational trade tool for the end user. The AI software product may use different types of processes to deliver incentives and track each end user. It may be in a form of, without limitation, virtual desktop system, software operating system, browser, and/or mobile apps. One thing that remains the same in different types of software is that they are AI customized for each industry category and by doing so it compartmentalizes each industry, the AI driven software infrastructure may be all in one stop shop that may have all the digital tools and services and supplies that a particular industry user may need.

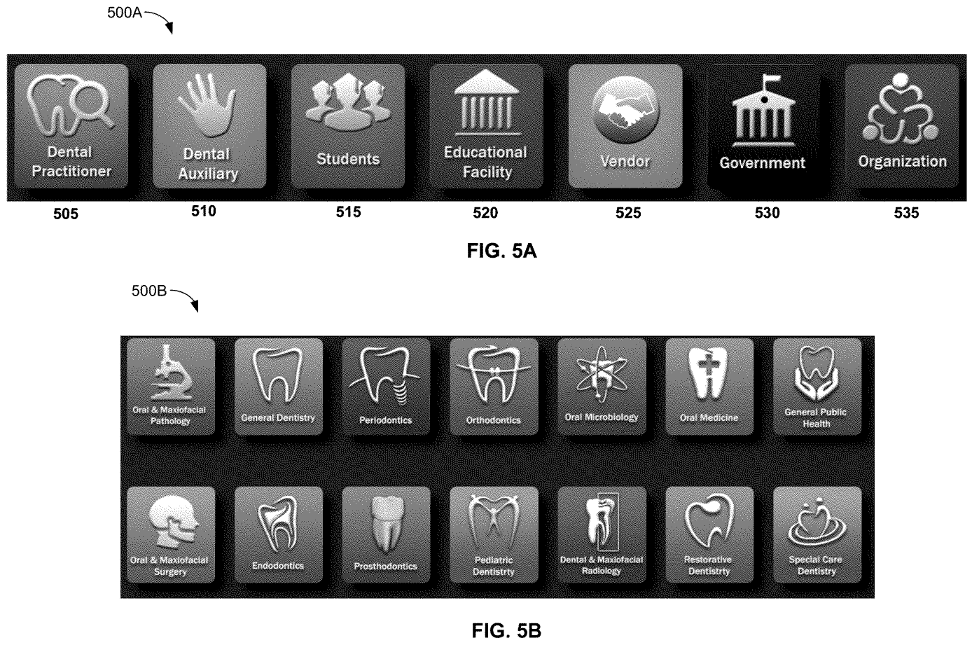

In other embodiments, AI virtual desktop (VD) software product and other forms of software (i.e., mobile apps, operating systems, etc.) may be provided for each specific industry. There may be one software module for dental industry, one for medical industry, a separate one for the legal industry, one for plumbing industry, another one for electricians, etc. See FIG. 5B. There may be a unique profession specific AI software module for each industry. Within each industry, there may even be more specific software versions for each subcategory specialist or auxiliary professional in that particular industry as well as business owners catering to that particular profession. For example, without limitation, there may be one AI software VD infrastructure, Operating system or Mobile App for a dentist and a different software module for a dental specialist like an Orthodontist and another one for each subcategory auxiliary, one for dental offices business, etc. The AI software product may have self-learning capabilities as well as computer networking where two or more computing devices are connected to enable transmission and exchange of information and resources, using a system of rules like communication protocols. Each AI virtual desktop system may have all the digital tools and access to services that is made for that particular industry. The AI virtual desktop system may provide a preconfigured view of operating systems and applications for the particular industry that may be accessed on different online devices through Wi-Fi and/or Internet connections. The AI virtual desktop system may be accessed remotely through any endpoint device that the particular industry may be using.

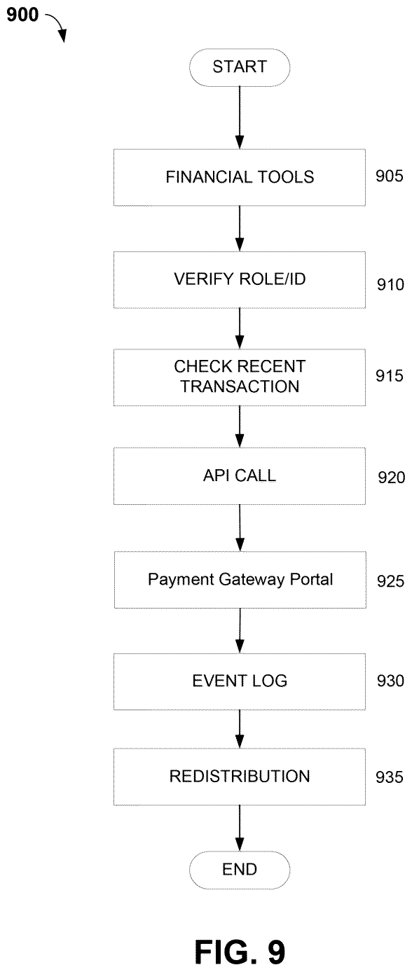

In further embodiments, a custom-made AI software product account may be issued for each individual that may allow educational institution, vocational/training schools, and organizations to track attending students and graduates/alumni in real time and for the rest of their lives and automatically, e.g., via a Server and/or AI engine, accounts for a portion of transaction amounts corresponding to their eligible interactions automatic redistribution that is redistributed, e.g., via an API (payments) gateway, to their particular educational institutions and member of an organization. The software of such embodiments may employ a unilevel or a multilevel redistribution plan through which it redistributes a certain calculated portion of a financial transaction back to the institutions from which the individual is locally affiliated with and/or graduated from in the databased of present system. Examples of eligible interactions an individual make may include, without limitations, making any financial transactions, any purchases from a physical store or an online store, taking a loan, paying taxes or any outstanding bills, etc. This may create a passive and automatic redistribution for the educational institutions, vocational schools, and organizations based upon the user's activity on the present AI VD networking system. Such that institutions no longer have to expect to have alumni donation. And may ultimately turn students and members into a redistribution generating entity for the school, vocational training programs or organizations. The method shown in FIG. 9 may enable network activity of students and members to auto-produce redistribution for their associated school(s), vocational training program(s) or organization(s).

In some embodiment, the AI software product compartmentalizes all industries globally by creating industry specific virtual desktops for each type of that not only provides industry specific tools that the individual user would need for its specific industry. AI VD infrastructure may streamline a new source of automatic redistributions to implement, maintain and support its application of AI technology for its global industry.

### Compartmentalization and Speed Enhancement

In an embodiment of the invention, a key architectural component may involve compartmentalizing each occupational industry into its own private global network (e.g. vertical segmentation). Each network may comprise, without limitation, AI-optimized software modules, infrastructure, and communication protocols tailored to the workflows, terminologies, and data transactions specific to that field. For example, without limitation, dentistry, law, and medical professionals would each operate on distinct, self-contained AI Virtual Desktop (VD) environments. Vertical segmentation of industries may not only enhance information security by isolating data flow within a controlled domain but may also vastly improve the speed and efficiency of digital interactions. Financial transactions within a compartmentalized network experience may reduce latency and faster validation because they are processed within a homogenous data environment where all parties may share common standards and verification systems. eCommerce may become more efficient due to pre-mapped supply chain dynamics and AI-assisted vendor-customer matching restricted to the specific professional domain. Interactions such as, without limitation, hiring, credential validation, vendor procurement, and service delivery may occur with minimal overhead since all contextual metadata is pre-aligned across all users in the same network.

Further, by narrowing the AI training and inference models to a domain-specific dataset within each private network, the self-learning capabilities of AI platforms (such as ChatGPT, DeepSeek, and other AI models) may be significantly amplified. These models may operate with higher context relevance, require less data preprocessing, and produce substantially more accurate outputs. For example, without limitation, a dentist inquiring about insurance code clarification or treatment protocol receives a faster, more accurate response because the query is processed within an isolated dental knowledge environment. Similarly, real-time extraction, processing, and response generation from AI platforms are enhanced due to minimized noise, absence of irrelevant cross-industry data, and reduced computational overhead for context filtration.

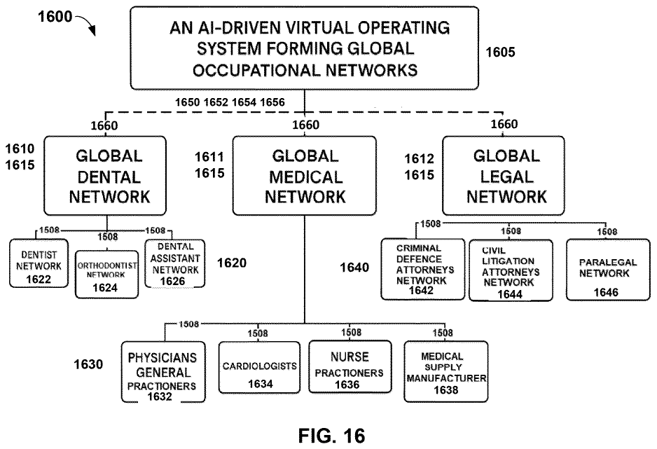

In another embodiment, by enabling each professional network to perform AI-enhanced data extraction and learning cycles from its own users' activities, the system may achieve faster evolution of field-specific best practices. For example, without limitation, AI modules within the legal network may refine themselves from legal precedents and contract structures, while those within medical networks learn patient workflows and diagnostic protocols. The result may be a globally synchronized AI infrastructure where industry-specific knowledge may evolve in silos optimized for vertical performance while still allowing selective, limited horizontal interaction across networks (e.g., between a doctor and a supplier). To illustrate these advantages, FIG. 16 may depict (1) the flow of a query through a compartmentalized professional network (versus a general-purpose network), and (2) the accelerated response time, financial transaction approval, and vendor-service mapping may be achieved via vertical network design. In some embodiments, FIG. 16 illustrates an exemplary AI-Driven Virtual Operating System Forming Global Occupational Networks A general-purpose AI network (multi-industry). A compartmentalized industry-specific AI network.

In other embodiments,

In further embodiments, on the task to convert all businesses, globally, into a single network and having organizations, schools and occupational/career colleges may mandate the use of the AI enhanced software product which may include a Virtual Desktop (VD) or mobile application or operating system that run on virtual machines (VMs) or workstations, accessible from any device with an internet connection, allowing users to access desktop environment and applications remotely in their course curriculum, by their alumni graduates, and group members. AI VD system is a “one-stop-shop” for everything a professional would need to practice their profession as well as for office business conduction. There may be different versions of the AI VD system. For example, there is one AI VD system version for dental offices, one for each dental specialty, as well as one for each subcategory staff/dental auxiliary. Each AI VD system version may be customized to the needs of that particular professional category. The AI VD system may include all the “bells and whistles” of dental digital tools/utilities (e.g. dental billing module, staffing module, auto-inventory module, office management module, etc.). To achieve this, an AI digital platform may track/guide dentist or a dental auxiliary throughout the course of their lives, automatically generate redistributions based on their transactions, increase their business automatic redistributions, automatize many dental office protocols and reduce their overhead as well as cost of living, which automatic system helps assure that within-network professionals (e.g., dentist and dental offices) gain greater financial efficiency, making it more likely for them to conduct more within-network transactions. At the same time, the present software may have dental schools, dental organization and dental career colleges assist assignment of the AI VD system to each enrolled student as well as alumni. In some embodiments, the present software may enable schools to offer incentives to end user doctor or auxiliary staff to encourage the daily use of AI VD system by both pre and post (dental or dental auxiliaries) grads and throughout the course of their lives.

In some embodiments, a customized AI guided-interactive digital-gateway application may be provided for any suitable occupation/industry; e.g., without limitation, one for Plumbing industry, one for electricians, legal industry, community, and dental industry, which may include, but is not limited to: dentist, dental specialists, dental auxiliary, dental offices, dental laboratories, dental education facilities (i.e., dental schools, dental vocational school, hygiene programs, etc.) government sector, governing dental organizations, dental labs, vendors and service providers. AI Virtual Desktop system may comprise, without limitation, a single interactive virtual desktop infrastructure where the global dental community may have access to all the interaction tools it needs to interact with other members of the global dental network and vendors. AI Virtual Desktop system may convert the entire global dental community to a single computer network to consolidate their equipment, supplies and services purchases to not only lower their overhead but convert all entities into an AI Virtual Desktop software model. In the process of “conversion” of the global dental community into a single franchise-like network, AI Virtual Desktop system may give governing bodies of dentistry and dental institutions the digital power to assist the AI Virtual Desktop system enforce the use of its platforms by the dental industry globally. As a form of redistribution, AI Virtual Desktop system may convert the global dental community (i.e. dentist, dental staff, dental schools, vocational dental auxiliary schools, dental organizations, dental manufactures, service providers, etc.) into a multi-tiered automatic redistribution sharing franchise to mandate the daily use of AI Virtual Desktop system by the global dental community. The AI Virtual Desktop system may allow, without limitation, all educational institutions and organizations to digitally track their students, graduating students (alumni), and current professional, throughout their entire course of life and careers, digitally guiding them along the way, while monetizing every aspect of daily interactions and transactions with an automatic redistribution share process. By doing so, these institutions may no longer see a need for alumni and corporate donations to support its own dental health related endeavors/projects. AI Virtual Desktop system also offers user incentives which may be free, depending on user's work dependency on AI Virtual Desktop system.

In other embodiments, AI Virtual Desktop system's AI-powered automation application may disrupt certain service providers and middle man suppliers; however, this global streamline disruption may create a new market dominance. AI Virtual Desktop's strategy is to complete alignment with our global network/partners, discretely, which may allow to simultaneously activate AI Virtual Desktop system AI digital applications on a global scale. By doing so, AI Virtual Desktop system may completely disrupt and divert all pre-existing streamlines market literately overnight. This way, it may not allow certain industry figures being disrupted from defensibly reacting to a shift on how the global dental business is conducted.

In further embodiments, the world is about to evolve with AI technology and it's time for the dental industry to set aside conventional business interactions/transactions networks, and instead prepare dentist to adjust and meet demands by way of using the present AI Virtual Desktop system for improving the efficiency of a modern professional practice, such as dentistry, and its outdated business processes. To achieve this, AI Virtual Desktop system intends to colonize the global dental community using AI technology and implement this change through an institutional model. That improvement includes creating the largest digital AI driven platform/ecosystem that is a self-sustainable network not only assists dentists manage their business interactions and transactions.

AI Virtual Desktop system intends to level the playing field in a number of ways which may include, without limitation, the use of AI enhanced image recognition system, with real time tracking, and analytics to track and manage dental business operations, which is not limited to: AI Virtual Desktop digital platforms which may include an AI enhanced virtual machine that basically puts the global dental and medical community on auto-pilot.

In additional embodiments, AI Virtual Desktop system may include, without limitation, an intellectual property software module may allow a unique application for enhanced AI with analytics. Specifically, AI Virtual Desktop system may comprise a plug and play software product that may allow the user to use security cameras to:
track staff to staff interaction, staff to doctor interaction, doctors to patient interaction, staff to equipment, staff to dental instruments, in real-time, to conduct and process office management and business protocols. It may detect behavior anomalies, using simultaneous object detection, tracking and analytics to replenish inventory, consolidation of global supply requests, logistic may have AI generated staff review platform that may have AI auto-generates staff work performance review and create a real-team resume to track work staff work history. AI Virtual Desktop system may have too many functions to list herein, however, its unique software functions may guide doctors to reduce doctor's business overhead, reduce staff turnover and maintain a uniform standard of care while increasing automatic redistribution and salary.
Auto-replenish supplies/services and streamline logistics and distribution using security camera devices. Using security camera devices in the dental office to track and identify equipment and dental supplies, track doctor, staff, patient interactions to identify dental procedures being performed and supplies being moved, identify those materials being used for each dental procedure, auto deduct those particular supply being used for that procedure from inventory. AI software then consolidating dental equipment and supplies using security cameras to streamline logistics, fulfillment centers. It auto-consolidates those supplies nationally or internationally, consolidates those particular dental supplies that needs to be inventory replenished individually auto-source supplies direct from factory. By doing so, not only the whole process of replenishing supplies is fully automated but AI-auto-consolidation of global goods and services may allow doctors, staff, dental offices and even dental manufactures to enjoy wholesale pricing for supplies, services financing, raw materials for manufacturing, etc., globally. Using dental institutions and organizations to implement successful use of AI technology to improve the science of dentistry and have AI software product design assist each member of the professional global dentistry through a lifelong learning.

In some embodiments, a role-specific AI-powered virtual desktop system comprising, without limitation, a dynamically generated graphical user interface (GUI) configured to serve as a centralized ‘digital shopping mall’ for professionals within regulated industries, such as, without limitation, dentistry. The GUI may include categorized interactive icons, menus, and/or windows tailored to user roles (e.g., dentists, assistants, specialists), granting access to services such as, without limitation, inventory management, financial tools, continuing education, credentialing, staffing, and patient management modules. Each GUI may be personalized by an AI engine based on, without limitation, user behavior, career progression, licensing data, and institutional affiliation. The system may include, without limitation, backend integrations with third-party vendors, APIs, AI-driven analytics engines, and a proprietary payment gateway. The invention may further enable educational institutions and organizations to track and automatic redistribution lifetime user transactions while reducing business overhead and automating professional workflows.

In some embodiments, the invention provides a comprehensive virtual desktop system tailored for professional industries, starting with the dental sector. The system leverages artificial intelligence to create personalized GUIs that may organize and deliver tools and services in a modular fashion, with categories such as, without limitation, Supplies & Inventory, Financial Tools, Patient Management, Staffing & Employment, Education & Certification, and Practice Operations.

In some embodiments, the invention provides a computer-implemented system for managing professional services within a regulated industry, comprising, without limitation, a virtual desktop system having a graphical user interface (GUI), a database storing role-based profiles for a plurality of users, an AI engine platform configured to analyze user behavior, licensing data, and institutional affiliations, a plurality of service icons displayed on the GUI, each icon corresponding to a vendor or utility in a professional domain, a payment gateway module integrated into the system for processing transactions via the GUI, wherein the GUI is dynamically customized for each user based on their role, behavior, and affiliation, and wherein user interactions with the GUI may trigger automated workflows including inventory management, financial processing, staffing coordination, or compliance tracking.

In some embodiments, the GUI is configured to include one or more icons, menus, and/or windows for accessing continuing education content based on the user's licensing state or jurisdiction. The AI engine platform is configured to generate and update a digital resume for the user based on tracked professional activity and performance scores. The one or more icons, menus, and/or windows may initiate a secure transaction using a proprietary financial gateway configured to route redistribution to an affiliated educational institution. The AI-integrated security camera device is used to track in-office behavior and update a performance dashboard. The GUI may be modified in real time as the user changes specialty, location, and/or licensing status.

The present invention will now be described in detail with reference to embodiments thereof as illustrated in the accompanying drawings.

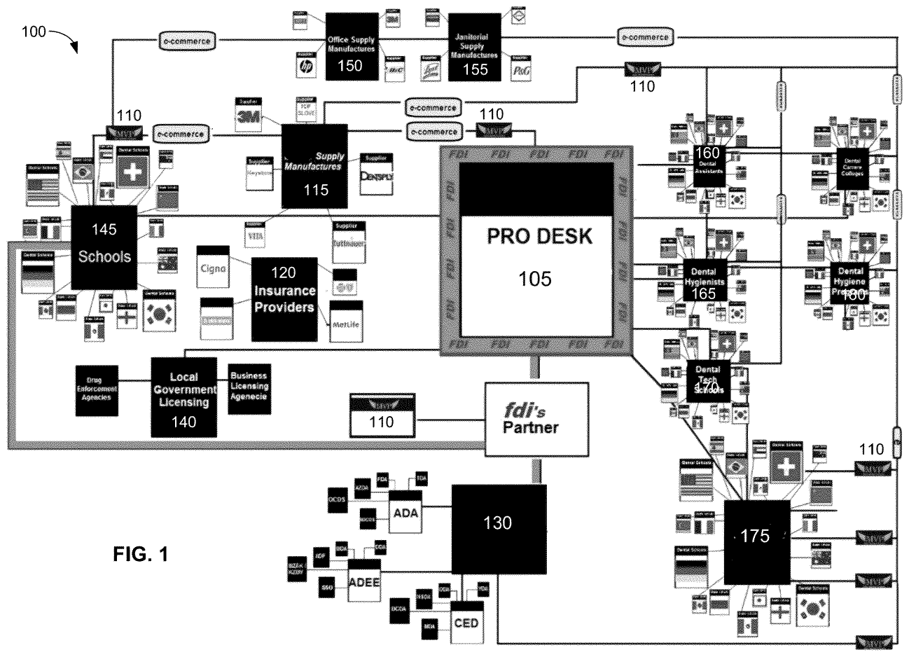

FIG. 1 is an illustration of an exemplary global profession-based network infrastructure, in accordance with an embodiment of the present invention. In one embodiment of the present invention, the task to convert all businesses, globally, into a single network and having organizations, schools 145 and occupational/career colleges 170 may mandate the use of the AI enhanced software product which may include a Virtual Desktop Infrastructure (VDI) 105 that run on virtual machines (VMs) or workstations, accessible from any device with an internet connection, allowing users to access desktop environment and applications remotely in their course curriculum, by their alumni graduates, and group members. AI VD infrastructure 105 is a “one-stop-shop” for everything a professional would need to practice their profession as well as for office business conduction. There may be different versions of the AI VD infrastructure. For example, there is one AI VD system version for dental offices 160, one for each dental specialty 165, as well as one for each subcategory staff/dental auxiliary 175. Each AI VD system version may be customized to the needs of that particular professional category. The AI VD system may include all the “bells and whistles” of dental digital tools/utilities 180 (e.g. dental billing module, staffing module, auto-inventory module, office management module, etc.). To achieve this, an AI digital platform may track/guide dentist or a dental auxiliary throughout the course of their lives, automatically generate redistributions based upon their financial transactions via proprietary payment gateway 110, increase their business automatic redistribution or salary, automatize many dental office protocols and reduce their overhead as well as cost of living. At the same time, the software may have dental schools 170, dental organization and dental career colleges assist assignment of the AI VD system to each enrolled student as well as alumni. In the same note, the schools may offer incentives to end user doctor or auxiliary staff to encourage the daily use of AI VD system by both pre and post (dental or dental auxiliaries) grads and throughout the course of their lives.

In some embodiments, an AI guided-interactive digital-gateway application may be provided for each industry. One for the Plumbing industry, one for electricians, office supply manufacturers 150, janitorial supply manufacturers 155, dentist 160, legal industry 120, government licensing 140, fdi's partner 130 which is not limited to dentist, dental specialists, dental auxiliary, dental offices, dental laboratories, dental education facilities (i.e., dental schools, dental vocational school, hygiene programs, etc.) government sector 140, governing dental organizations, dental labs, vendors 115, and service providers.

In other embodiments, AI VD infrastructure 105 may identify all products using image recognition system and consolidate the same products ordered throughout the global network and consolidate them into a single order which gets to the factory to obtain a bulk purchase which in turn may be to obtain distributors price. Getting rid of the middle man retailer.

In further embodiments, virtual desktop 105 may allow third-party software companies and service providers to place their app or software for dentist or dental offices or dental auxiliaries access. There may be many third-party utility apps that our AI Virtual desktop may house. The AI virtual desktop may sort out and categorize similar third-party service Apps and display in their particular service category. The virtual desktop may have AI enhanced capabilities, where it may allow third-party desk top apps to communicate with each other on the software private network. For instance, if a dentist is looking for a job his resume may automatically be available to all dental office hiring. If a dentist wants to build a dental office or a house, it may obtain an AI generated floor plan and engineering design that is offered through a third-party app on the virtual desktop. There may be an app on the software for advertising, one for repair/maintenance, another one for purchasing supplies and equipment, another one for financial services, etc.

In another embodiment, incentives for end users to use the software, free utility software may be offered to help manage their business or assist in obtaining jobs and work opportunities. To provide occupational and life decision guidance so the user becomes successful. The dental protocols, like ordering supplies, managing office procedures, staff management. To consolidate all the dental supplies globally and or nationally to reduce product cost or service costs. Bulk-order through consolidation of all supply and service orders to obtain order directly from factory or supplier. Thus, eliminating the middle man. For example, without limitation, if a pen is bought in California using the platform, all the pen orders get consolidated and sent to factory for factory direct price, all the orders get sent to fulfillment center and get distributed individually from there.

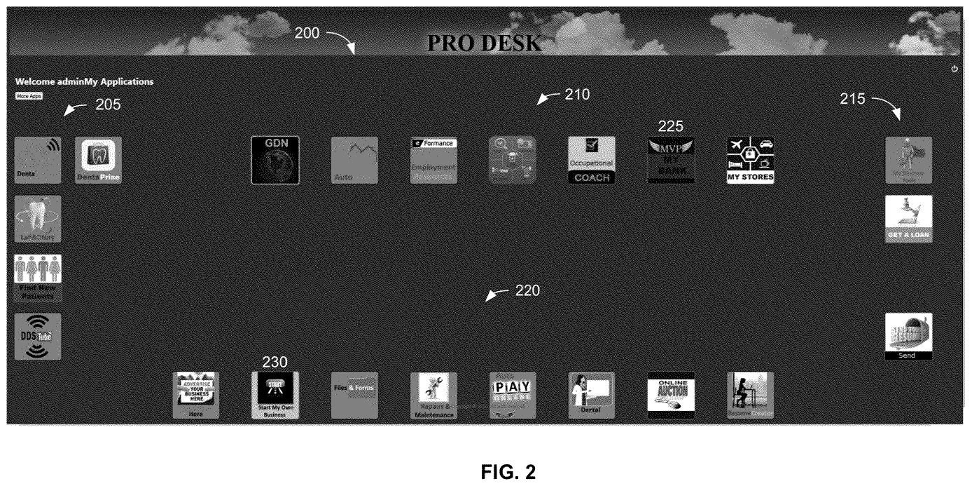

FIG. 2 is an illustration of an exemplary AI-based virtual desktop 105 showing a digital mall graphical user interface (GUI) 200, in accordance with an embodiment of the present invention. The AI virtual desktop is shown that exemplifies an all-in-one stop shop for a dental profession 205. The AI virtual desktop may have digital tools 205-220 a dentist would need in their profession. The “digital shopping mall” 200 and anything the professional does on this profession based virtual desktop, operating system, mobile app or profession-based software, the school and organizations get a redistribution based upon that transaction amount, which could be calculated by any suitable formula, to include, without limitation, simple percentages. Digital mall 200 may include vendors 205 and service providers 210 220 that exclusively provide supplies and services. This way the user does not randomly have to find supplies and services doing internet search.

In some embodiment of the present invention, a comprehensive virtual desktop infrastructure tailored for the dental sector is provided. The system leverages artificial intelligence (AI) to create personalized digital mall graphical user interface (GUI) 200 that may organize and deliver tools and services in a modular fashion.

The VD or Operating System that is dedicated to only dentist have its own dentist only network. All orthodontists have their own version of VD and their own private individual network from the dentist's network. Dental auxiliaries may have their own VD or Operating system or Mobile operating system in a private network of their own. However, all these private networks have a limited interactions with each other as needed. For instance, when a dentist needs a staff member, the dentist's network may reach out to the dental assistant network to seek the potential candidate that is available. Now to better understand the type of contents of the supplies and services would be offered on each version of the professional virtual desktop or operating system, may use the virtual desktop for a general dentist. Its virtual desktop would contain videos that are related to dentist and the dental field. Anything from how to use each particular dental equipment to performing a certain dental procedure and all aspects of patient care, how to market your business effectively, improving interpersonal skills in dentistry, etc., e-commerce options, financial services, free diagnostic software, free management software, patient referral software (to refer patients to other specialties, etc). The objective is the more dentist use the software the freer utility software (that whey would normally pay subscription for) would become free to use. Other software would be for access to dental laboratory tracking software. It also allows third-party service providers to offer their services to end user dentist through this software. For instance, it may have third-party AI agents' software that may guide in personal and business mater.

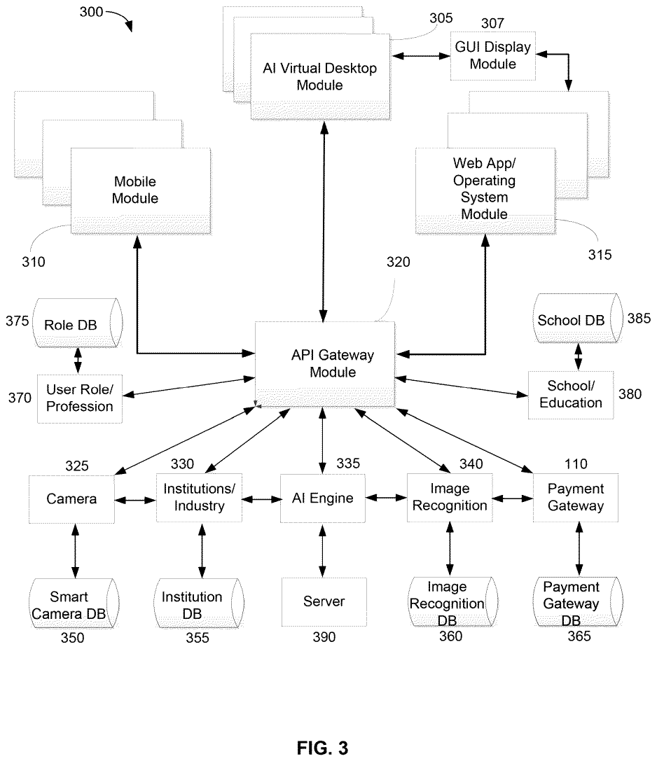

FIG. 3 is an illustration of an exemplary network 300 using at least an API Gateway module 320 as a service, in accordance with an embodiment of the present invention. In one embodiment of the present invention, network 300 may include, without limitations, as inputs, an AI VD module 305, a mobile module 310 and a web module 315. The input modules 305 310 315 may connect to a single endpoint, API Gateway module 320, that is configured to forward requests to various/individual microservices including, without limitation, user role/profession 370, school/education 380, smart camera 325, institutions/industry 330, AI engine 335, image recognition 340 and payment gateway 110. Databases 350-365 375 385 may be coupled to microservices 325-340 110 370 and 380. Network 300 may comprise an API Gateway and software pattern acting as a single-entry point for API calls, managing traffic, enforcing policies, and routing requests to backend services, essentially acting as a traffic conductor between inputs (clients) and microservices. API Gateway pattern 320 may be split in multiple services or multiple smaller API Gateways and segregated based on, without limitation, education, business and/or organizational boundaries. Institutions/Industry 330 may include, without limitation, educational facilities/organizations, business organizations, manufacturers, office suppliers, legal industry, dental industry, role, etc. where Institutions/Industry DB 355 is a database for storing above designations. AI VD module 305 and/or Web module 315 may be coupled to a graphical user interface (GUI) display screen/monitor 307 such as, without limitation, touch screens, LCD, LED, OLED, CRT, and curved or gaming monitors.

In other embodiments, mobile module 310 may include a mobile/portable phone and an AI VD mobile app. AI VD module 305 may include a virtual machine and an AI VD app. And Web module 315 may include a web virtual machine and an AI VD web app. AI VD module 305 may also be a cloud-based virtual desktop. If a virtual desktop app may not be downloaded onto a mobile app, the software may built-in and be an entire mobile phone operating system that may be download over your current mobile phone operating system or it may be a cloud-based AI VD. The AI VD can also have a cloud-based AI VD if using outside pc or for whatever reason cannot operate the AI VD on local hard drive.

In other embodiments, API Gateway 320 may act as a single-entry point for clients such as, without limitation, AI VD 305, Mobile 310 or Web 315 to access API endpoint(s) or backend microservice(s) such as, without limitation, user role/profession 370, school/education 380, smart camera 325, institutions/industry 330, AI engine 335, image recognition 340 and payment gateway 110. API Gateway 320 may route requests, aggregate responses, and may provide security and management features, while simplifying the client's interaction with the microservices. For instance, without limitation, API Gateway 320 may receive requests from AI VD 305, Mobile 310 or Web 315 and routes them to the appropriate microservices or API endpoint, including, without limitation, user role/profession 370, school/education 380, smart camera 325, institutions/industry 330, AI engine 335, image recognition 340 and payment gateway 110, based on predefined parameter fields. Predefined parameter fields may include, without limitation, a tag ID parameter field, a professional based parameter field, an occupational parameter field, a subcategory specialists parameter field, a virtual desktop action parameter field. Each parameter field may comprise, without limitation, name, ID, school/institution, occupation and specialty (e.g. name, ID, school/institution, occupation, specialty). A microservice or API endpoint server 390 may receive client 305 310 and/or 315 request, may validate the received request, and then processes the received request to retrieve a requested data or perform a requested action. Server 390 may generate a response based on the request and the data it retrieved or the action it performed and sends a response back to AI VD 305, Mobile 310 and/or Web 315, which may use the data or the result of the action.

In further embodiments, the following parameter fields may enable network 300 to carry out the multi-level automatic redistribution sharing process:

### A Tag ID Parameter Field:

Each educational facility and organizations may digitally tag each member of their students, graduates/alumni and organization members through an electronic registration process.

### A Professional Based Parameter Field:

And being assigned and issued a unique professional based VD, operating system and/or mobile app that belongs to a specific professional field that may have its own private network.

### An Occupational Based Parameter Field:

There may be a specific network for each occupational field and each registered individual may select their field of practice and once they register, they may become part of their global network that is specific for that particular field. For example, all dentists in the world may have their own private network and be assigned a virtual desktop or operating system customized for exclusively used by dentists.

### A Subcategory Specialists Parameter Field:

All subcategory specialists in the dental field, each may have their own individual network as well as unique desktop that may have all the desktop applications that a specialist needs. For instance, an orthodontist, may register as an orthodontist, may be issued a Virtual desktop or an operating system or a mobile application specifically for an orthodontist that may have all the utilities and apps that an orthodontist may use.

### A Virtual Desktop Action Parameter Field:

For issuing, downloading, displaying and/or installing a Virtual desktop or an operating system or a mobile application for at least one of the professional, occupational and subcategory specialist (e.g. like a orthodontist), the VD may have all the utilities and apps that the user may operate.

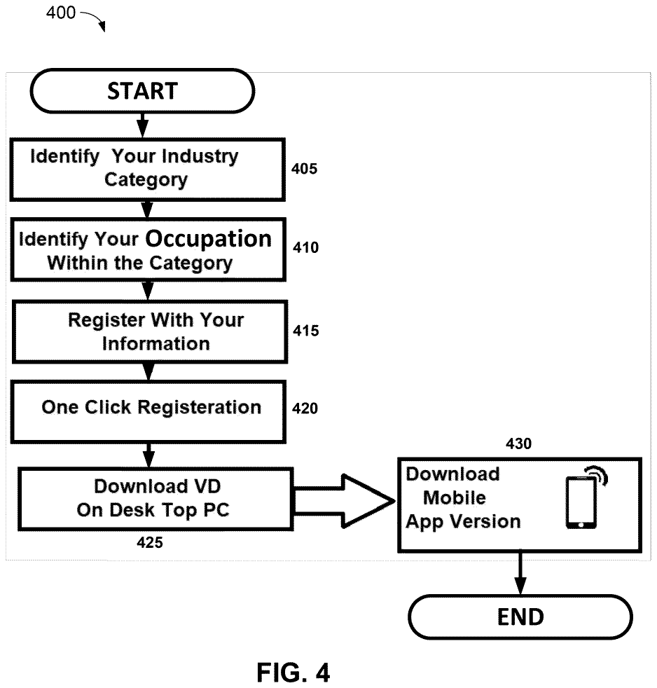

In some embodiment, regarding the predefined parameter fields, each educational facility and/or organization may digitally tag each member of their students, graduates/alumni and organization members through an electronic registration process. Issue a tag ID parameter field (e.g. ID, school) and being assigned and issued a unique professional virtual desktop action parameter field (e.g. AI VD ID, entity) to download, install and display on AI VD 305, web app/operating system 315 and mobile app 310 that belongs to a specific professional field or institution/industry 330 that may have its own private network 300. There may be specific network for each occupational field 370 and each registered individual may select their field of practice. Once they register, they may become part of a profession-based global network 100 specific for that particular field (e.g. see FIG. 4). By way of example for the dental occupation, dentists anywhere in the world may each have their own private network 300 and be assigned virtual desktop 305, web app/operating system 315 and/or mobile app 310 customized for use by dentists. All subcategory specialists in the dental field may have their own individual network 300 as well as unique virtual desktop 305 that may have desktop applications that a specialist needs. For instance, a user may register as an orthodontist, may be issued virtual desktop 305, web app/operating system 315 or mobile application 310 specifically for an orthodontist that may have all the utilities and apps that an orthodontist may use. By doing this, each school or organization may be able to track each individual student or alumni who graduated from their facility or member of their organization and automatically generate redistributions based upon their interaction and transactions throughout the course of their entire lives.

In other embodiments, referring to FIGS. 2 and 3, AI engine/software 335 is self-learning. AI VD 305 or operating system 315 takes related types of services and products and automatically organizes them based on relevance. If a business may have certain equipment 205 210, AI may allow job seekers to find out what equipment 205 210 that particular business may have and provide training videos 210 on the equipment prior to applying for job. AI may consolidate supply orders and service 220.

In further embodiments, image recognition system 340 and/or security cameras 325 may be used to identify similar items and consolidate that particular item into a bulk purchase (Nationally or internationally) and forward it to a factory to obtain factory price. Cameras 325 may be used to identify supplies and equipment and auto replenish supplies. Users may be pre-qualified in real time for loans since the system tracks automatic redistribution in real time-to-time. One aspect of the present embodiment, is to provide a single dedicated professional (e.g., without limitation, local, regional, and/or global) network that provides the user an easy-to-use system that may bring some or all of the professional specific digital trade tools right to the user's desktop. By doing so, obtaining business license, occupational license, obtaining insurance and signing up for utilities may occur with a simple one click process on a “Start My Own Business” 230 interactive icon that may be displayed on GUI display module 307 using the software. AI engine 335 may recommend where to move geographically, a precise location to open up your business. Camera 325 may be tracking your use of home supplies, personal services and personal items also get consolidated to obtain factory price or lowest service price possible. Lowering personal expenses as well as business expenses is vital to succeeding in life.

In some embodiments, AI VD software 305 is a desk top application that may allow 3^{rd} party applications park their apps/service on the desktop, under the category and allows those apps to interact in real time. AI VD software 305 may guide each user, AI agent throughout the course of their life. It is like having an AI agent 335 that learns of your personal interaction and transactions and assists you to make business and personal decisions.

In other embodiments, AI engine software 335 may automatically use image recognition system 340 to automatically offer limited network access and link chain the professional VD or Operating systems for certain network interactions. For instance, the VD/operating system for dental supply factories may be communicating with the network to receive consolidated orders, receive logistics information, obtain reduced shipping costs, etc.

In some embodiments, referring to FIGS. 1-3, a single dedicated professional network globally 100 that may have an easy-to-use system 300 that brings all the professional specific digital trade tools right to the user's desktop is provided. By doing so, obtaining business license, occupational license, obtaining insurance and signing up for utilities may occur with a simple one click process. Pretty much everything that an individual needs to start their own business with a click of a button on a “Start My Own Business” 230 interactive icon that may be displayed on GUI display module 307. Also, if one moves to an apartment or a house, with a click of a button, the system may automatically apply for utilities like gas, electric, phone, etc.

FIG. 4 is an illustration of an exemplary global registration flowchart, in accordance with an embodiment of the present invention. In one embodiment of the present invention, a user may select which industry they are in through the registration process in a Step 405. In a Step 410, the user may identify an occupation within the category. In Step 415, the user may select to register the industry and occupation information. In a Step 420, the user may verify the registration by clicking on a registration icon, button or menu. In a Step 425, AI VD app 305 may be downloaded on a digital equipment used by the user such as, without limitation, desktop PC, laptop, notebook, etc. And, in a Step 430, AI VD app 305 may be additionally downloaded on a mobile device.

FIG. 5A is an illustration of an exemplary dental AI VD GUI 500A for registration, in accordance with an embodiment of the present invention. In one embodiment of the present invention, referring to FIGS. 1-3 and FIG. 5A, AI Virtual Desktop system 300 may comprise, without limitation, an interactive virtual desktop infrastructure 305 where the global dental community 200 may have access to all the interaction tools it needs to interact with other members of global dental network 100 and vendors 205 via graphical user interface (GUI) 200. GUI 200 may allow users to interact with the AI Virtual Desktop system 305 using visual elements like icons, menus, and buttons displayed on screen/monitor 307. AI Virtual Desktop system 305 may convert the global dental community to a single computer network 300. In the process of “conversion” of the global dental community into a single software model, AI Virtual Desktop system 305 may give governing bodies of dentistry and dental institutions the digital power to assist the AI Virtual Desktop system enforce the use of its platforms by the dental industry globally. As a form of redistribution, AI Virtual Desktop system may convert the global dental community (i.e. dentist, dental staff, dental schools, vocational dental auxiliary schools, dental organizations, dental manufactures, service providers, etc.) into a multi-tiered automatic redistribution sharing franchise to mandate the daily use of AI Virtual Desktop system by the global dental community. The AI Virtual Desktop system may allow, without limitation, all educational institutions and organizations to digitally track their students, graduating students (alumni), and current professional, throughout their entire course of life and careers, digitally guiding them along the way, while monetizing every aspect of daily interactions and transactions with a automatic redistribution share process. By doing so, these institutions may no longer see a need for alumni and corporate donations to support its own dental health related endeavors/projects. AI Virtual Desktop system also offers user incentives which may be free, depending on user's work dependency on AI Virtual Desktop system.

Once the user specifies which department (e.g. 505-535) user is in dentistry by clicking on the department, then the GUI may go to the next page (see FIG. 5B) for a more specific sub category. For instance, without limitation, if the user is an Oral Surgeon, user may click on Dental Practitioner 505 and then additional options would pop up on the screen, from which user may continue to select user category.

FIG. 5B is an illustration of an exemplary student registration GUI 500B, in accordance with an embodiment of the present invention. For instance, without limitation, when the user clicks on Dental Practitioner, additional options 500B would pop up on the screen, as shown, from which the user may continue to select education/professional category.

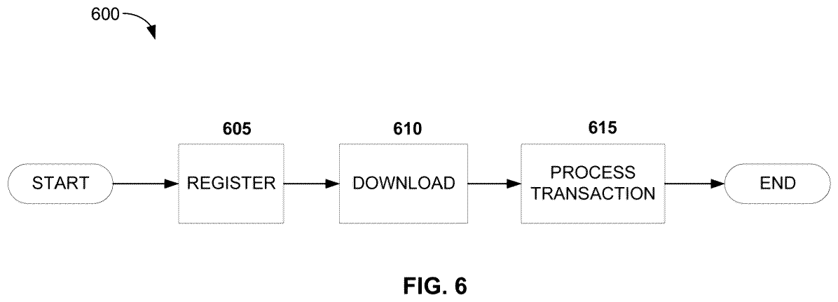

FIG. 6 is an illustration of an exemplary registration process flowchart 600, in accordance with an embodiment of the present invention. In one embodiment of the present invention, in a Step 605, a student, graduate/alumni, professional and organization may register by entering an educational institution/facility, vocational/training school or organization and/or at least one of a full name and email. Each educational institution/facility and/or organizations may digitally tag each member of their students, graduates/alumni, professional and organization members through the registration process. A tag ID parameter field may be issued to the student or graduate/alumni. The tag ID parameter field may comprise, without limitation, a school ID and school/institution (e.g. ID, school). A professional based parameter field may be assigned to professionals and issued a unique professional based AI VD, operating system and/or mobile app that belongs to a specific professional field that may have its own private network. The professional based parameter field may comprise, without limitation name and profession (e.g. name, profession). An occupational parameter field may be assigned to individuals based on their occupation. The occupational parameter field may comprise, without limitation, name and occupation (e.g. name, occupation). A subcategory specialists parameter field may be assigned to specialists. For instance, an orthodontist may register as an orthodontist. The subcategory specialist's parameter field may comprise, without limitation name and subcategory specialist (e.g. name, subcategory specialist).

In an alternate embodiment, registration process 605 may comprise Step 405-Step 415 of FIG. 4. For example, without limitation, a user may select which industry they are in a list of buttons or a menu. The user may identify an occupation within a list of buttons or a menu of the category. And, the user may select a button or menu to register the industry and occupation information.

In a Step 610, the student, graduate/alumni, professional or organization may download an AI VD software product (i.e., virtual desktop app 305, operating system 315 and/or mobile app 310) using their virtual desktop action parameter field (VDAPF). There may be a specific network for each occupational field and each registered individual may select their field of practice and once they register, they may become part of a global network that is specific for their particular field. For example, all dentists in the world may have their own private network and be assigned a virtual desktop or operating system customized for exclusively used by dentists. All subcategory specialists in the dental field, may have their own individual network as well as unique desktop that may have all the desktop applications that a specialist needs. For instance, the orthodontist may be issued a Virtual desktop, operating system or a mobile application specifically for an orthodontist that may have all the utilities and apps that an orthodontist may use. The virtual desktop action parameter field (e.g. AI VD ID, entity) may be issued for downloading, displaying and/or installing the virtual desktop, operating system or mobile application for the entity such as, without limitation, professional, occupational or subcategory specialists (e.g., like an orthodontist). The AI VD may have all the utilities and apps. The virtual desktop action parameter field may comprise an AI VD ID and entity (e.g. AI VD ID, entity).

In a Step 615, the software product may have its own payment gateway module or contract module with a payment gateway system 110 to process all transactions made by a user. The software product may use AI engine 335 to track all other types of financial transactions and charge a processing fee for the transactions. The fee may be distributed through a redistribution plan.

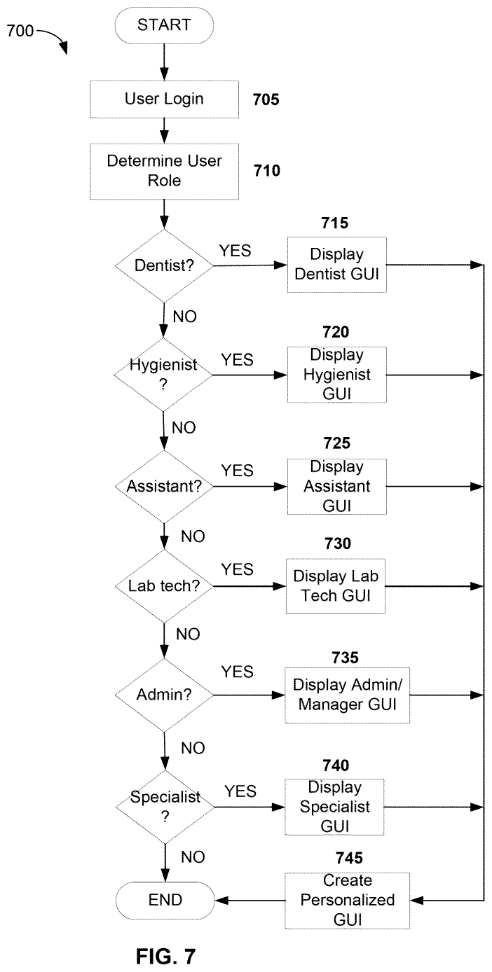

FIG. 7 is an illustration of an exemplary access flowchart by professional groups 700, in accordance with an embodiment of the present invention. In one embodiment of the present invention, in a Step 705, a user may login to a role-specific AI-powered virtual desktop system 305 by entering a full name, email, institution ID, field of practice, specialization, graduation year, device type and/or location. The role-specific AI-powered virtual desktop system 305 comprising, without limitation, a dynamically generated graphical user interface (GUI) configured to serve as a centralized ‘digital shopping mall’ for professionals within a regulated industry. The GUI may include categorized interactive icons tailored to user roles which may include dentists 715, hygienist 720, assistants 725, lab technicians 730, admin/manager 735 and specialists 740. In a Step 710, the system determines the user role when it detects an activation of one of the interactive icons. The system granting access to services such as, without limitation, inventory management, financial tools, continuing education, credentialing, staffing, and patient management based on the user role. Each GUI may be personalized by AI engine 335 based on user behavior, career progression, licensing data, and institutional affiliation. The system may include, without limitation, backend integrations with third-party vendors 205 220, APIs 320, AI-driven analytics engines 335, and a proprietary payment gateway 110. The invention may further enable educational institutions and organizations 145 to track and automatically generate lifetime redistributions based upon user transactions while reducing business overhead and automating professional workflows.

In some embodiments, the invention provides a comprehensive virtual desktop infrastructure 105 tailored for professional industries, starting with the dental sector 160-170. The system leverages artificial intelligence (AI) 335 to create a personalized graphical user interface (GUI) 200 and 500A-B that may organize and deliver tools and services in a modular fashion, with categories such as, without limitation, Supplies & Inventory, Financial Tools, Patient Management, Staffing & Employment, Education & Certification, and Practice Operations.

In other embodiments, a computer-implemented system for managing professional services within a regulated industry is provided, comprising a virtual desktop interface 305 with graphical user interface (GUI) screen 307, a user database 350-365 storing role-based profiles for a plurality of users, an AI engine 335 configured to analyze user behavior, licensing data, and institutional affiliations, a plurality of service icons 200 500A-B displayed on the GUI, each icon corresponding to a vendor or utility in a professional domain, a payment gateway 110 integrated into the system for processing transactions via the GUI, wherein the GUI is dynamically customized for each user based on their role, behavior, and affiliation, and wherein user interactions with the GUI trigger automated workflows including, without limitation, registration 400 600, user role identification 700, inventory management 205, financial processing, staffing coordination 210, or compliance tracking.

In further embodiments, the GUI is configured to include one or more icons 500A-500B for accessing continuing education content based on the user's licensing state or jurisdiction. AI engine 335 is configured to generate and update a digital resume for the user based on tracked professional activity and performance scores. The one or more icons may initiate a secure transaction using proprietary financial gateway 110 configured to route redistribution to an affiliated educational institution. An AI-integrated security camera 325 coupled to an image recognition system 340 may be used to track in-office behavior and update a performance dashboard. The GUI is modified in real time as the user changes specialty, location, or licensing status.

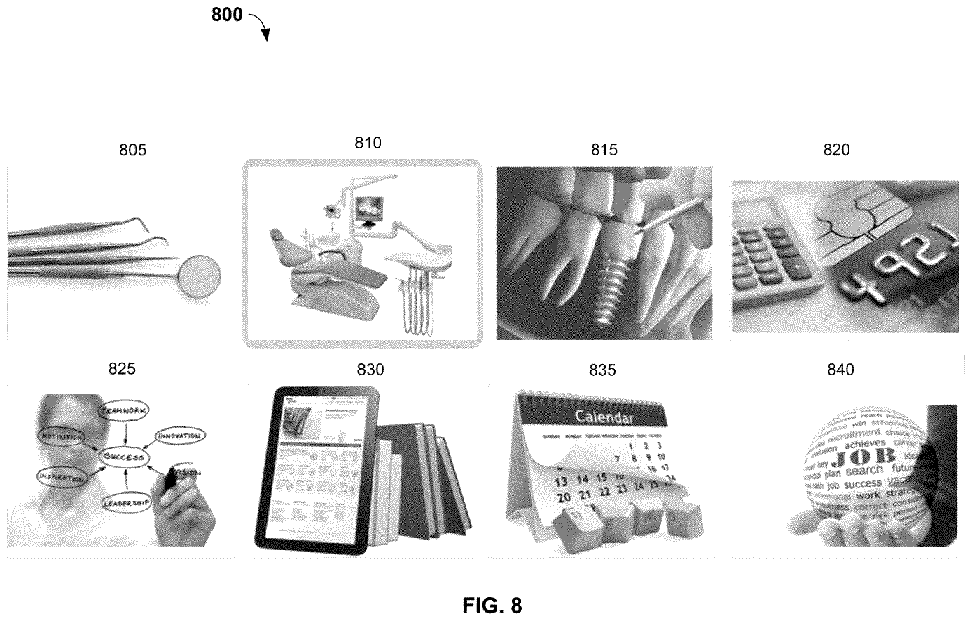

FIG. 8 is an illustration of an exemplary GUI depicting categories of vendors and tools 800, in accordance with an embodiment of the present invention. In one embodiment of the present invention, AI Virtual Desktop infrastructure 105 may comprise, without limitation, an interactive virtual desktop system 305 where the global dental community may have access to interaction tools it needs to interact with other members of the global dental network and vendors via graphical user interface (GUI) 800, as shown. GUI 800 may allow users to interact with the AI Virtual Desktop system 305 using visual elements like icons, menus, and buttons. AI Virtual Desktop system 305 may convert the entire global dental community to a single computer network via API gateway 320 to consolidate equipment and supplies 805, repair and maintenance services 810, laboratory services 815, financial and insurance services 820, practice and occupational management services 825, education and data services 830, dental events and news services 835 and employment services 840. As part of an API gateway pattern multiple client requests (usually HTTP requests) 305-315 may be aggregated targeting multiple internal microservices 325-340 and 110 into a single client request. For example, without limitation, the gateway pattern may be convenient when AI VD app 305 needs information from several microservices 325-340 110. AI VD app 305 may send a single request to API Gateway 320 that may dispatch several requests to microservices 325-340 and 110 and then aggregates the results and sends everything back to AI VD app 305. Dental purchases would not only lower overhead but convert entities into an AI Virtual Desktop software model. In the process of “conversion” of the global dental community into a single software model, AI Virtual Desktop system 305 may give governing bodies of dentistry and dental institutions 330 the digital power to assist the AI Virtual Desktop system enforce the use of its platforms by the dental industry globally. As a form of redistribution, AI Virtual Desktop system 305 may convert the global dental community (i.e. dentist, dental staff, dental schools, vocational dental auxiliary schools, dental organizations, dental manufactures, service providers, etc.) into a multi-tiered automatic redistribution sharing franchise to mandate the daily use of AI Virtual Desktop system 305 by the global dental community. The AI Virtual Desktop system may allow, without limitation, educational institutions and organizations 330 to digitally track their students, graduating students (alumni), and current professional, throughout their entire course of life and careers, digitally guiding them along the way, while monetizing every aspect of daily interactions and transactions with a automatic redistribution share process. By doing so, these institutions may no longer see a need for alumni and corporate donations to support its own dental health related endeavors/projects. AI Virtual Desktop system 305 also offers user incentives which may be free, depending on user's work dependency on AI Virtual Desktop system.

In some embodiments, there may be a sub-category networks within each general industry network. By way of example for the dental occupation, the dental industry is provided its own Network. Within the dental network, there are sub-network(s) within the main dental network which is comprised of each dental specialty, dental related business, sub-staff (i.e., dental assistance, hygienist, dental laboratory, etc.). Oral surgeons may have their own Virtual Desktop 305 or Operating system 310 and network 300 within the dental network. Endodontists may have their own network within the dental network, dental assistance may have their own. Dental offices (a business) may have their own. Medical Doctors have their own network.

FIG. 9 is an illustration of an exemplary financial flowchart 900, in accordance with an embodiment of the present invention. Flowchart 900 illustrates a process of how the software converts a single financial transaction into an institutional redistribution. In a Step 905, a user takes out a loan from a bank to purchase a real estate such as, without limitation, a building, a house, etc. The user opens a financial tool that is on the virtual desktop. The user verifies his identify in a Step 910. Then the user checks recent financial transactions in a Step 915, including “see loan options” and “select loan options”.

In a Step 920, an API Call is made where AI VD 305 sends a request to payment gateway portal 110 via API Gateway 320. In a Step 925, payment gateway portal 110 receives the request, validates the received request, processes the received request, and retrieves the requested data or perform the requested action. For instance, the request may include preparing redistribution payment. A server may generate a response based on the received request, retrieved data or action performed. The server sends the response back to AI VD 305. Another API CALL may occur where payment gateway 110 may communicate with the AI VD 305 to update the transaction history and event log in a Step 930. The redistribution gets calculated and transferred to the university, organization and/or institution in a Step 935.

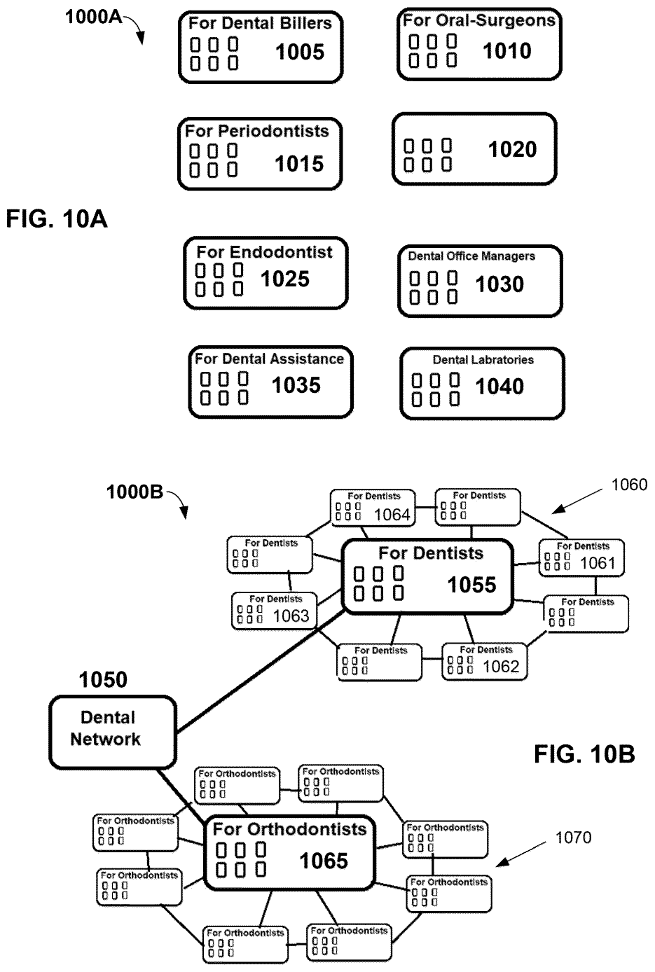

FIG. 10A is an illustration of an exemplary dental network software modules 1000A, in accordance with an embodiment of the present invention. In one embodiment of the present invention, digital tools (e.g. 3^{rd} party software or other utility software) that appear for an Oral Surgeon desk top 1010 may be different from that of an Endodontist 1025 and software modules 1005 1015 1020 1030 1035 and 1040. Also, the supplies in the ecommerce (e.g. from factory to dentist) may only focus on Oral Surgeon supplies as an Oral Surgeon may not need to buy or use third party software made for another sub category specialist. Software modules 1005 1015 1020 1030 1035 and 1040.

In some embodiments, the software modules are illustrations showing that there would be an exclusive virtual desktop 305 or operating system 315 for each subcategory dental professional or its auxiliary or office staff. Software modules 1005-1040 for instance, are multiple illustrations showing various dental categories having their own private AI virtual desktop (VD). As an example, without limitations, dental billers 1005 may have their own virtual desktop, and each virtual desktop may have software utilities and access to material and services that dental biller 1005 would need to have. Oral surgeons 1010 may have their own virtual desktop, as well as periodontist 1015, dental office managers 1030, dental laboratories 1040, etc.

FIG. 10B is an illustration of an exemplary dental network modules 1000B, in accordance with an embodiment of the present invention. In one embodiment of the present invention, dentists 1055 may have their own network 1060 and orthodontists 1065 may have their own network 1070. In some embodiments, the exemplary illustration shows virtual desktops 305 for each dentist 1055 are part of a global collective and a private network for dentists. That Orthodontists 1065 have their own private network. Dental network 1050 shows that private dentist network 1055 and orthodontic network 1065 communicate with each other's network on a limited basis and as needed. For instance, when a dentist wants to refer an orthodontic patient to an orthodontist, there may be a referral portal in dental network 1050 that may allow the dentist to pass the patient to an orthodontist. Dentists network 1060 may allow dentists 1061 to interact with other dentist 1062-1064 as needed basis for various reasons. For instance, AI consolidating dental supplies and services, confirming employee history, transferring patient dental records, etc. Orthodontists network 1070 is demonstrating the same but for orthodontists.

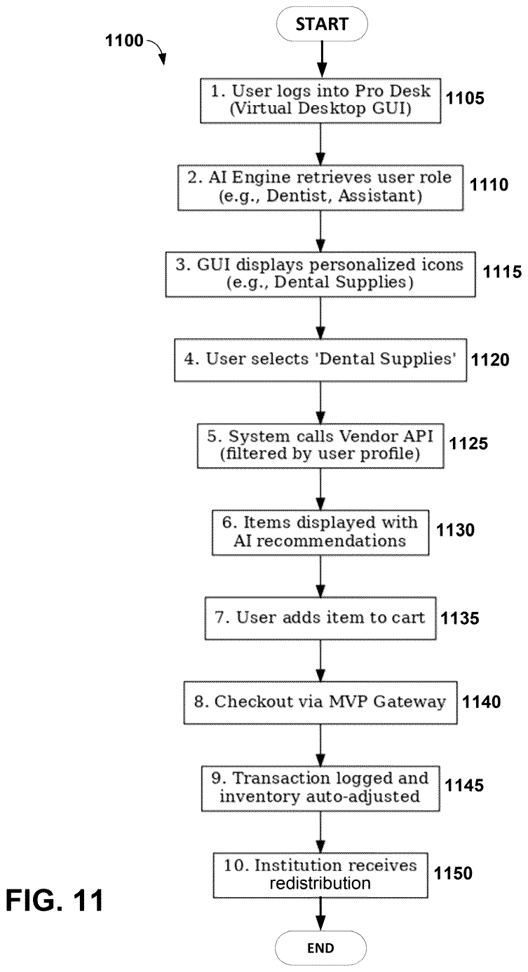

FIG. 11 is an illustration of an exemplary dental supply purchasing process flowchart 1100, in accordance with an embodiment of the present invention. In a Step 1105, logging in a global network system with AI VD module 305, mobile module 310 or web module 315 by entering one or more of a name, email, institution ID, field of practice, specialization, graduation year, device type, location, etc. In a Step 1110, user role retrieved. In a Step 1115, personalized icons are displayed. In a Step 1120, user selects dental supplies. In a Step 1125, system calls vendor API filtered by user profile. In a Step 1130, items displayed with AI recommendations. In a Step 1135, user selects an item and adding item to cart. In a Step 1140, checkout via any payment gateway privately contracted (i.e., MVP gateway is an example of white brand payment gateway). In a Step 1145, transaction logged and inventory adjusted. In a Step 1150, institution receives automatic redistribution share.

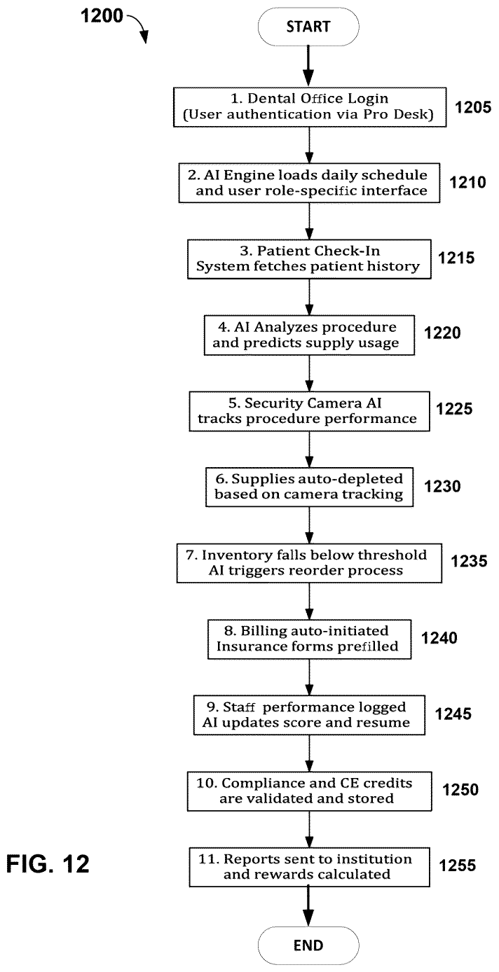

FIG. 12 is an illustration of an exemplary dental workflow process flowchart 1200, in accordance with an embodiment of the present invention. In a Step 1205, a user login a dental office by entering one or more of a name, email, institution ID, field of practice, specialization, graduation year, device type, location, etc. via a virtual operating environment. In a Step 1210, AI engine 335 loads daily schedule and user role interface. In a Step 1215, patient checks in the system and fetches patient history. In a Step 1220, AI engine 335 analyzes procedure and predicts supply usage. In a Step 1225, security camera 325 tracks procedure performance. In a Step 1230, supplies are auto depleted based on camera tracking 325 and image recognition 340. In a Step 1235, inventory falls below a predetermined threshold. In turn, AI engine 335 triggers reorder process. In a Step 1240, billing may be auto-initiated. Insurance forms may be prefilled. In a Step 1245, staff performance may be logged. AI engine 335 may update score and resume. In a Step 1250, compliance and CE credits may be validated and stored in a database such as, without limitation, institution DB. In a Step 1255, redistribution may be calculated and sent to an institution, industry and/or organization.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

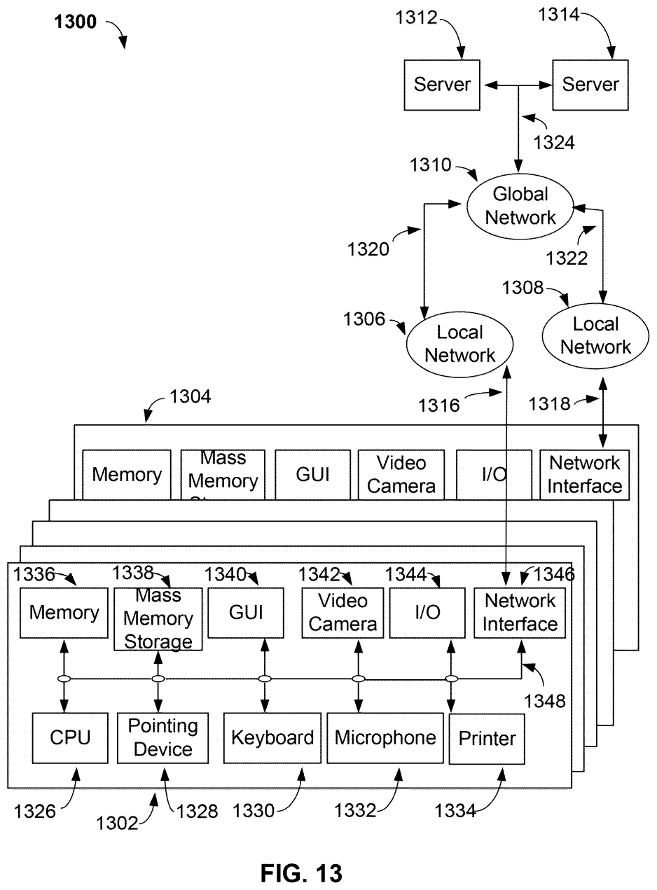

FIG. 13 is a block diagram depicting an exemplary client/server system which may be used by an exemplary web/Internet enabled/networked embodiment of the present invention.

A communication system 1300 includes a multiplicity of clients with a sampling of clients denoted as a client 1302 and a client 1304 designated as AI virtual desktops 305, a multiplicity of local networks with a sampling of networks denoted as a local network 1306 and a local network 1308, a global network 1310 and a multiplicity of servers with a sampling of servers denoted as a server 1312 and a server 1314 acting as microservices.

Client 1302 may communicate bi-directionally with local network 1306 via a communication channel 1316 including, without limitation, API gateway 320. Client 1304 may communicate bi-directionally with local network 1308 via a communication channel 1318 including, without limitation, API gateway 320. Local network 1306 may communicate bi-directionally with global network 1310 via a communication channel 1320. Local network 1308 may communicate bi-directionally with global network 1310 via a communication channel 1322. Global network 1310 may communicate bi-directionally with server 1312 and server 1314 via a communication channel 1324. Server 1312 and server 1314 may communicate bi-directionally with each other via communication channel 1324. Furthermore, clients 1302, 1304, local networks 1306, 1308, global network 1310 and servers 1312, 1314 may each communicate bi-directionally with each other.

In one embodiment, global network 1310 may operate as the Internet. It will be understood by those skilled in the art that communication system 1300 may take many different forms. Non-limiting examples of forms for communication system 1300 include local area networks (LANs), wide area networks (WANs), wired telephone networks, wireless networks, or any other network supporting data communication between respective entities.

Clients 1302 and 1304 may take many different forms. Non-limiting examples of clients 1302 and 1304 include personal computers, personal digital assistants (PDAs), cellular phones and smartphones.

Client 1302 includes a CPU 1326, a pointing device 1328, a keyboard 1330, a microphone 1332, a printer 1334, a memory 1336, a mass memory storage 1338, a GUI 1340, a video camera 1342, an input/output interface 1344 and a network interface 1346.

CPU 1326, pointing device 1328, keyboard 1330, microphone 1332, printer 1334, memory 1336, mass memory storage 1338, GUI 1340, video camera 1342, input/output interface 1344 and network interface 1346 may communicate in a unidirectional manner or a bi-directional manner with each other via a communication channel 1348. Communication channel 1348 may be configured as a single communication channel or a multiplicity of communication channels.

CPU 1326 may be comprised of a single processor or multiple processors. CPU 1326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general-purpose microprocessors.

As is well known in the art, memory 1336 is used typically to transfer data and instructions to CPU 1326 in a bi-directional manner. Memory 1336, as discussed previously, may include any suitable computer-readable media, intended for data storage, such as those described above excluding any wired or wireless transmissions unless specifically noted. Mass memory storage 1338 may also be coupled bi-directionally to CPU 1326 and provides additional data storage capacity and may include any of the computer-readable media described above. Mass memory storage 1338 may be used to store programs, data and the like and is typically a secondary storage medium such as a hard disk. It will be appreciated that the information retained within mass memory storage 1338, may, in appropriate cases, be incorporated in standard fashion as part of memory 1336 as virtual memory.

CPU 1326 may be coupled to GUI 1340. GUI 1340 enables a user to view the operation of computer operating system and software. CPU 1326 may be coupled to pointing device 1328. Non-limiting examples of pointing device 1328 include computer mouse, trackball and touchpad. Pointing device 1328 enables a user with the capability to maneuver a computer cursor about the viewing area of GUI 1340 and select areas or features in the viewing area of GUI 1340. CPU 1326 may be coupled to keyboard 1330. Keyboard 1330 enables a user with the capability to input alphanumeric textual information to CPU 1326. CPU 1326 may be coupled to microphone 1332. Microphone 1332 enables audio produced by a user to be recorded, processed and communicated by CPU 1326. CPU 1326 may be connected to printer 1334. Printer 1334 enables a user with the capability to print information to a sheet of paper. CPU 1326 may be connected to video camera 1342. Video camera 1342 enables video produced or captured by user to be recorded, processed and communicated by CPU 1326.

CPU 1326 may also be coupled to input/output interface 1344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1326 optionally may be coupled to network interface 1346 which enables communication with an external device such as a database or a computer or telecommunications or internet network using an external connection shown generally as communication channel 1316, which may be implemented as a hardwired or wireless communications link using suitable conventional technologies. With such a connection, CPU 1326 might receive information from the network, or might output information to a network in the course of performing the method steps described in the teachings of the present invention.

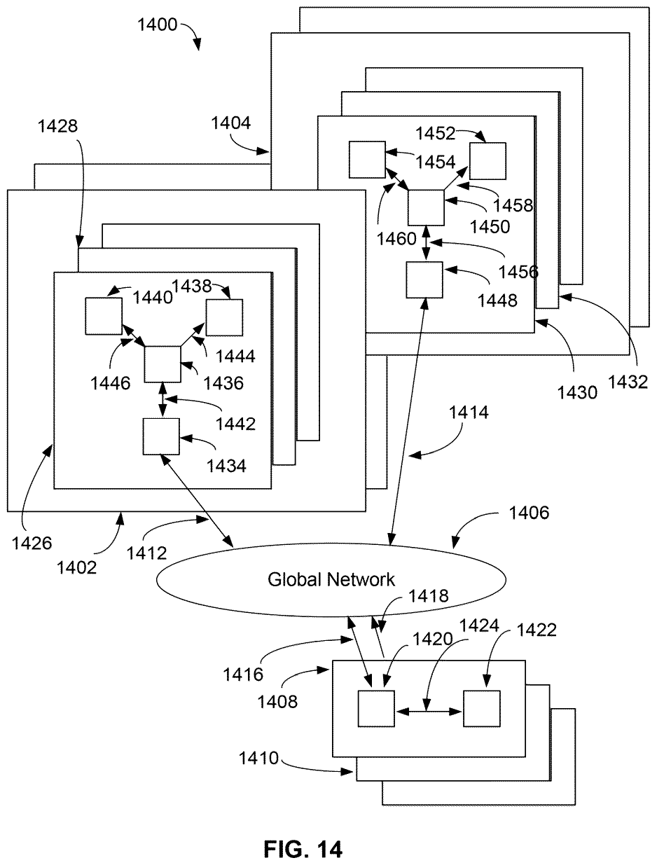

FIG. 14 illustrates a block diagram depicting an exemplary client/server communication system, which may be used by a web-enabled/networked embodiment of the present invention.

A communication system 1400 includes a multiplicity of networked regions with a sampling of regions denoted as a network region 1402 and a network region 1404, a global network 1406 and a multiplicity of servers with a sampling of servers denoted as a server device 1408 and a server device 1410.

Network region 1402 and network region 1404 may operate to represent a network contained within a geographical area or region. Non-limiting examples of representations for the geographical areas for the networked regions may include postal zip codes, telephone area codes, states, counties, cities and countries. Elements within network region 1402 and 1404 may operate to communicate with external elements within other networked regions or within elements contained within the same network region.

In some implementations, global network 1406 may operate as the Internet. It will be understood by those skilled in the art that communication system 1400 may take many different forms. Non-limiting examples of forms for communication system 1400 include local area networks (LANs), wide area networks (WANs), wired telephone networks, cellular telephone networks or any other network supporting data communication between respective entities via hardwired or wireless communication networks. Global network 1406 may operate to transfer information between the various networked elements.

Server device 1408 and server device 1410 may operate to execute software instructions, store information, support database operations and communicate with other networked elements. Non-limiting examples of software and scripting languages which may be executed on server device 1408 and server device 1410 include C, C++, C# and Java.

Network region 1402 may operate to communicate bi-directionally with global network 1406 via a communication channel 1412. Network region 1404 may operate to communicate bi-directionally with global network 1406 via a communication channel 1414. Server device 1408 may operate to communicate bi-directionally with global network 1406 via a communication channel 1416. Server device 1410 may operate to communicate bi-directionally with global network 1406 via a communication channel 1418. Network region 1402 and 1404, global network 1406 and server devices 1408 and 1410 may operate to communicate with each other and with every other networked device located within communication system 1400.

Server device 1408 includes a networking device 1420 and a server 1422. Networking device 1420 may operate to communicate bi-directionally with global network 1406 via communication channel 1416 and with server 1422 via a communication channel 1424. Server 1422 may operate to execute software instructions and store information.

Network region 1402 includes a multiplicity of clients with a sampling denoted as a client 1426 and a client 1428. Client 1426 includes a networking device 1434, a processor 1436, a GUI 1438 and an interface device 1440. Non-limiting examples of devices for GUI 1438 include monitors, televisions, cellular telephones, smartphones and PDAs (Personal Digital Assistants). Non-limiting examples of interface device 1440 include pointing device, mouse, trackball, scanner and printer. Networking device 1434 may communicate bi-directionally with global network 1406 via communication channel 1412 and with processor 1436 via a communication channel 1442. GUI 1438 may receive information from processor 1436 via a communication channel 1444 for presentation to a user for viewing. Interface device 1440 may operate to send control information to processor 1436 and to receive information from processor 1436 via a communication channel 1446. Network region 1404 includes a multiplicity of clients with a sampling denoted as a client 1430 and a client 1432. Client 1430 includes a networking device 1448, a processor 1450, a GUI 1452 and an interface device 1454. Non-limiting examples of devices for GUI 1438 include monitors, televisions, cellular telephones, smartphones and PDAs (Personal Digital Assistants). Non-limiting examples of interface device 1440 include pointing devices, mousse, trackballs, scanners and printers. Networking device 1448 may communicate bi-directionally with global network 1406 via communication channel 1414 and with processor 1450 via a communication channel 1456. GUI 1452 may receive information from processor 1450 via a communication channel 1458 for presentation to a user for viewing. Interface device 1454 may operate to send control information to processor 1450 and to receive information from processor 1450 via a communication channel 1460.

For example, consider the case where a user interfacing with client 1426 may want to execute a networked application. A user may enter the IP (Internet Protocol) address for the networked application using interface device 1440. The IP address information may be communicated to processor 1436 via communication channel 1446. Processor 1436 may then communicate the IP address information to networking device 1434 via communication channel 1442. Networking device 1434 may then communicate the IP address information to global network 1406 via communication channel 1412. Global network 1406 may then communicate the IP address information to networking device 1420 of server device 1408 via communication channel 1416. Networking device 1420 may then communicate the IP address information to server 1422 via communication channel 1424. Server 1422 may receive the IP address information and after processing the IP address information may communicate return information to networking device 1420 via communication channel 1424. Networking device 1420 may communicate the return information to global network 1406 via communication channel 1416. Global network 1406 may communicate the return information to networking device 1434 via communication channel 1412. Networking device 1434 may communicate the return information to processor 1436 via communication channel 1442. Processor 1426 may communicate the return information to GUI 1428 via communication channel 1444. User may then view the return information on GUI 1438.

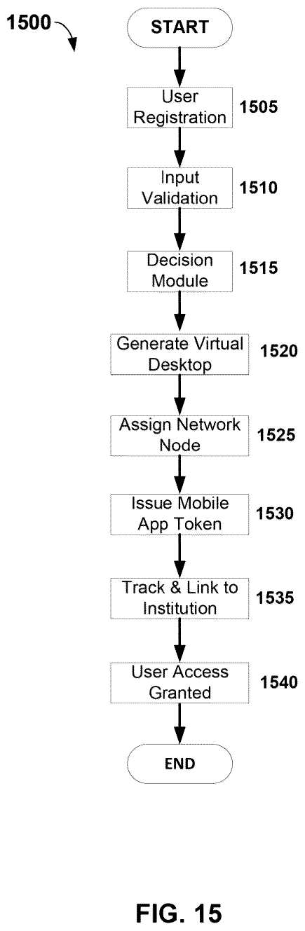

FIG. 15 is an illustration of an exemplary flowchart 1500 depicting a multi-level automatic redistribution sharing process, in accordance with an embodiment of the present invention. In a Step 1505, user registers in the system by entering/inputting one or more of a full name (e.g. full legal name of the user), email, institution ID (identifier for school or organization), field of practice (e.g., “dentistry”), specialization (e.g., “orthodontics”), graduation year, device type (e.g. desktop or mobile) and/or location (e.g. geographic location for network segmentation). In a Step 1510, user registration input fields are validated by the system. In a Step 1515, assign the appropriate virtual environment (e.g. Creates customized VD instance, OS, or App, links user with institution, connects or creates secure network node) based on the professional's registration details and specialization. In a Step 1520, a virtual desktop is generated. In a Step 1525, a network node may be assigned. In a Step 1520, a mobile app token may be issued. In a Step 1535, track and link user to an institution. In a Step 1540, network access may be granted.

The following software code may instruct one or more processors to create: a Unique User Profile, a Profession-Specific Virtual Desktop, a Mobile App Access Token, a Routing to Private Global Network, an Analytics Dashboard for Institutions as follows:

```
IF field_of_practice is recognized:
  IF specialization exists in field:
    Assign specialization-specific VD and Network
  ELSE:
    Assign field-level default VD and Network
  Generate tracking tag linked to institution_id
  Route user to corresponding private network node
ELSE:
  Return error: “Field of practice not recognized”
```

FIG. 16 is a flowchart 1600 of an exemplary AI-Driven Virtual Operating System Forming Global Occupational Networks 1605, in accordance with an embodiment of the present invention. When deployed across multiple users in the same field, these Virtual Desktops may collectively form a profession-specific global network(s) 1610 that may act as a private, occupation-centered infrastructure exclusive to that industry (e.g., a global dental network 1610, a global medical network 1611, or a global legal network 1612). Each profession-specific global network or global networks 1610 may operate as a closed-loop professional ecosystem. Within each profession-specific global network 1610 1611 1612, the system may further compartmentalize users into sub-category networks 1620 1630 1640, dedicated to specific roles or specialties within that profession or global network 1611. For instance, profession-specific global network 1610 may further compartmentalize into a dentist network 1622, orthodontist network 1624 and/or dental assistant network 1620, and so forth.

Some embodiments of the present invention relate to an Artificial Intelligence (AI)-powered Virtual Desktop (VD) system 1605, operating system, or mobile operating system that is specifically customized for users within distinct occupational fields. Each instance of the system is tailored to the workflows, tools, compliance frameworks, terminology, and collaboration needs of a given profession, providing intelligent automation, contextual decision support, and secure real-time data exchange. When deployed across users in the same profession, these virtual systems collectively form Profession-Specific Global Occupational Networks 1610 1611 1612, each representing a private, AI-enhanced infrastructure for that field, such as, but not limited to a global dental network 1610, global medical network 1611, or global legal network 1612. Each Profession-Specific Global Network 1610 1611 1612 may be structurally isolated to ensure field-specific optimization and information integrity, yet may be capable of controlled cross-network interaction via AI-mediated protocols 1615.

Within each global network 1610 1611 1612, users may be further compartmentalized into Subcategory Occupational Networks 1620 1630 1640 that may represent specific roles or specialties. Each Subcategory Network 1620 1630 1640 may operate vertically from the core profession specific global network 1610 1611 1612, enabling specialization without diluting the integrity of the overarching professional infrastructure. Examples of these hierarchical structures may include, without limitation, a Global Dental Network 1610 including sub-networks 1620 for General Dentists 1622, Dental Specialists (e.g., Orthodontists, Endodontists) 1624, and Dental Auxiliary Staff (e.g., Hygienists, Assistants) 1626. A Global Medical Network 1611 including sub-networks 1630 for Primary Care Physicians 1632, Specialists (e.g., Cardiologists, Neurologists) 1634, Nurse Practitioners 1636 and Medical Technologists 1638. And a Global Legal Network 1612 including sub-networks 1640 for Litigation Attorneys 1644, Regulatory Attorneys 1642, Paralegals, and Legal Aides 1646.

While these global networks 1610 1611 1612 may segregated by industry, the AI protocols 1615 may allow for selective, compliant, and secure communication between them through AI-Mediated Cross Network Interaction. An example of cross network interaction may be Intra-Industry Staffing in which general dentist 1622 may submit a hiring request for dental assistant 1620. In this example, the AI queues and directs a hiring request 1650 within the Dental Global Network 1610, specifically to the Dental Assistant Sub-Network 1626. Another example is a Cross-Industry Medical Clearance in which the same dentist may request a patient's medical clearance. The AI securely routes the medical clearance request 1652 to a physician 1632 in the Medical Global Network 1611, generally ensuring privacy and compliance. Yet another example is a Legal-to-Healthcare Referral 1654 in which a personal injury attorney from the Legal Global Network 1612 may refer a client for dental evaluation. The AI identifies the proper dental specialist within the Dental Global Network 1610 and coordinates referral 1654 securely. This architecture supports secure inter-professional collaboration 1656, without compromising the autonomy or data integrity of any field.

It is contemplated that embodiments of the present invention may promote various capabilities and impacts 1660, including, without limitation, Vertical Specialization such as role-specific AI tools aligned with professional needs, modular scalability wherein each network can grow independently, enabling localized or global adoption, data isolation which may ensure sensitive information remains within its intended occupational boundary, selective interoperability which may enable secure referrals, hiring, or data exchange across professional networks when authorized, etc. By organizing professionals into occupation-specific ecosystems and refining their operational structure through AI, the system may accelerate eCommerce, workforce management and data transactions. Moreover, this compartmentalization may dramatically enhance AI learning by narrowing data sources to industry-specific contexts, which typically increases the speed and accuracy of AI responses across platforms like ChatGPT, DeepSeek, or similar systems.

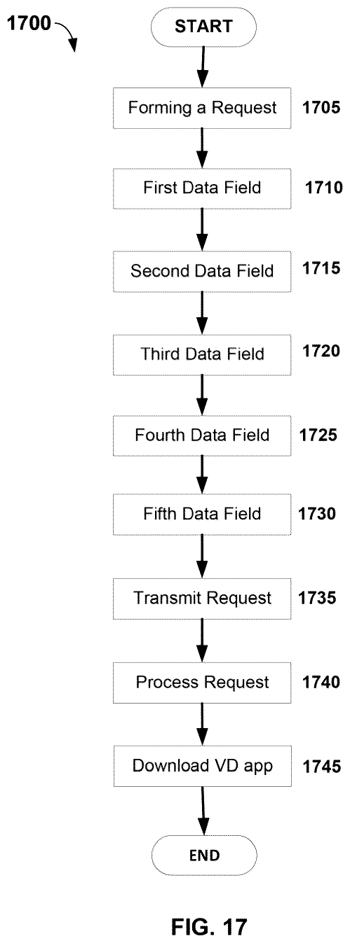

FIG. 17 is an illustration of an exemplary flowchart 1700 depicting a method for forming an API request for a virtual desktop application, in accordance with an embodiment of the present invention.

In a Step 1705, a request to download an artificial intelligence based networked virtual operating environment may be sent to one or more API server(s). The request may be formed to include, without limitation, at least five (5) data fields, whether alone or in combination.

In a Step 1710, a first data field, may be configured as a tag ID parameter field operable for identifying a user in the network may be included in the request. Each educational facility and organization may digitally tag each member of their students, graduates/alumni and organization members through the electronic registration process.

In a Step 1715, a second data field value may be configured as a professional based parameter field operable for identifying a professional based AI VD may be included in the request. And may be assigned and issued a unique professional based VD, operating system and/or mobile app that belongs to a specific professional field that may have its own private network.

In a Step 1720, a third data field configured as an occupational based parameter field operable for identifying an occupation may be included in the request. There may be a network for each occupational field and each registered individual may select their field of practice and once they register, they may become part of their global network that is specific for that particular field. For example, each dentist in the world may have their own private network and be assigned a virtual desktop or operating system customized for exclusively used by dentists.

In a Step 1725, a fourth data field value may be configured as a subcategory specialists parameter field operable for identifying a subcategory specialist in a dental field may be included in the request.

In a Step 1730, a fifth data field value may be configured as a virtual desktop action parameter field operable for providing a client of a virtual operating environment. This field is operable for issuing, downloading, displaying and/or installing a Virtual desktop or an operating system or a mobile application for at least one of the professional user, occupational user and subcategory specialist (e.g. like a orthodontist). The VD may have all the utilities and apps that the user may operate.

In a Step 1735, a request may be formed containing one or more field(s), alone or in combination, and may be transmitted to the one or more API server(s).

In a Step 1740, the API server(s) may process the request. And, in a Step 1745, the server may deliver or download and/or install the requested artificial intelligence based networked virtual operating environment for the user to operate.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC § 112(6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC § 112(6). In some embodiments, the methods and/or system components which may be located and/or performed remotely.

It is noted that according to USA law, all claims must be set forth as a coherent, cooperating set of limitations that work in functional combination to achieve a useful result as a whole. Accordingly, for any claim having functional limitations interpreted under 35 USC § 112(6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC § 112 (6) is/(are) dependent on one or more remote servers located outside the USA, it is intended that each such recited function under 35 USC § 112(6) is to be interpreted as the function of the local system receiving the remotely generated information required by a locally implemented claim limitation, wherein the structures and or steps which enable, and breathe life into the expression of such functions claimed under 35 USC § 112(6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC § 112(6)” should be replaced with the closest corresponding statute in the patent laws of such pertinent country or countries or legal organization(s).

In other embodiments, AI staff management software: security camera may track staff, dentist and patient and review each staff's work performance, daily and individually in real time and AI may generate a digital resume which may go into Pro Desk's network. This way it when the staff decides to leave, all doctors see a genuine resume. AI generates a five-star performance review that is impartial and according to a uniform set of values. This way, it eliminates accusation of being fired unjustly and also since staff knowing that AI is creating a daily review, it may be a deterrent to conducting themes unprofessionally. Also, the individual who accumulate an average of 4 or 5 stars may be lotteried into a chance to win a vacation, a car or a house in their district. The ones that have a 1 or 2 or 3 must take courses. The automatic redistribution generated by the software may be reinvested into creating incentive's and rewarding staff conduct in each state or province in each country.

In further embodiments, AI inventory software: using security camera and office software to track all patients, staff and doctors in-office interactions, to calculate supply usage and deduct that from inventory and auto replenish inventory as needed. Each order gets consolidated by AI software and gets directed to factory.

AI software may be personal agent (consultant), which may guide each dentist and dental assistant personal and professional to make both financial and personal decisions.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112(6) requires that structures corresponding to functional limitations interpreted under 35 USC § 112(6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112(6). Applicant(s) note that all the identified documents above which are incorporated by reference to satisfy 35 USC § 112(6) necessarily have a filing and/or publication date prior to that of the instant application, and thus are valid prior documents to incorporated by reference in the instant application.

Having fully described at least one embodiment of the present invention, other equivalent or alternative methods of implementing artificial intelligence virtual desktop infrastructures according to the present invention will be apparent to those skilled in the art. Various aspects of the invention have been described above by way of illustration, and the specific embodiments disclosed are not intended to limit the invention to the particular forms disclosed. The particular implementation of the artificial intelligence virtual desktop infrastructure may vary depending upon the particular context or application. By way of example, and not limitation, the artificial intelligence virtual desktop infrastructure described in the foregoing were principally directed to global network implementations; however, similar techniques may instead be applied to remote controlled robots/drones, or managing any local/regional/global occupational networks, which implementations of the present invention are contemplated as within the scope of the present invention. Moreover, those skilled in the art, in light of the foregoing teachings, will readily recognize how to configure suitable AI VD system networks for other suitable occupations than the foregoing dental industry embodiments and examples presented. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

1. A non-transitory computer-readable storage medium with an executable software program product stored thereon, wherein the program instructs one or more processors to perform a method comprising the following steps of:
registering a user in a global network system on a graphical user interface (GUI) of an artificial intelligence (AI) virtual desktop (VD) module;
retrieving the user role stored on a role database (DB) based on an institution ID and a location or a field of practice and a specialization;
arranging interactive icons on a graphical user interface (GUI) of said artificial intelligence (AI) virtual desktop (VD);
wherein said interactive icons comprise a digital mall;
detecting an activation of at least one interactive icon displayed on said digital mall;
wherein in response to said interactive icon being activated, issuing a request to contact at least one of a vendor and a service provider that provide supplies and services; and
detecting an activation of one or more items from recommendations provided by the vendor and/or service provider by said GUI detecting at least a click on one or more of the item recommended by the vendor and/or service provider.

2. The method of claim 1, further comprising the steps of:
determining a number and/or amount of selected supply items;
providing a payment for the item(s) via a payment gateway;
logging the transaction.

3. The method of claim 2, further comprising the steps of:
adjusting inventory; and
sending automatic redistribution share to institution.

4. The method of claim 1, further comprising the steps of:
detecting an activation of one or more member or department of a global dental community; and
presenting at least one of an education and professional category.

5. The method of claim 2, wherein the step of logging in said global network system comprises entering at least one of an institution ID and a location.

6. The method of claim 2, wherein the step of logging in said global network system comprises entering said field of practice and specialization.

7. The method of claim 1, wherein the step of arranging interactive icons comprises interacting with an AI Virtual Desktop system using visual elements like icons, menus, and buttons displayed on said GUI screen/monitor.

8. The method of claim 7, wherein the step of arranging interactive icons further comprises arranging at least one of a dental practitioner icon, a dental auxiliary icon, student icon, educational facility icon, vendor icon, government icon and an organization icon.

9. A software program product comprising:
an artificial intelligence (AI) virtual desktop (VD) software code for guiding a user based on a predefined industry or profession;
an AI VD graphical user interface (GUI) software code for visually presenting the predefined industry or profession in the form of an interactive icon, menu and/or buttons on a screen/monitor;
a security camera software code for tracking or identifying at least one of supplies and equipment of the predefined industry or profession;
an AI engine software code for learning personal interaction or transactions and assists in making business and/or personal decisions of the predefined industry or profession;
a payment gateway software code for generating redistributions based upon financial transactions and/or processing financial transactions of the predefined industry or profession;
an image recognition software code for identifying similar items and consolidate the items into a bulk purchase or tracking in-office behavior and updating a performance dashboard; and
a user role/profession software code for determining a configuration of an artificial intelligence (AI) virtual desktop (VD) based on a user role of the predefined industry or profession.

10. A non-transitory computer-readable storage medium with an executable software program product stored thereon, wherein the program instructs one or more processors to perform a method comprising the steps of:
registering and/or creating a professional and/or occupational artificial intelligence (AD based networked virtual operating environment;
forming and submitting to an Application Programming Interface (API) gateway, by a client, a request to create the professional and/or occupational AI based networked virtual operating environment, the request comprises:
a first data field value, wherein said first data field value comprises a tag ID parameter field that is configured to be operable for identifying a registered member/user of a facility or organization in the network;
a second data field value, wherein said second data field value comprises a professional based parameter field that is configured to be operable for identifying a professional based AI virtual desktop (VD) operating environment;
a third data field value, wherein said third data field value comprises an occupational based parameter field that is configured to be operable for identifying an occupation of the member/user;
a fourth data field value, wherein said fourth data field value comprises a subcategory specialist parameter field that is configured to be operable for identifying a subcategory specialist in a dental field, said subcategory specialist comprises at least an orthodontist;
a fifth data field value, wherein said fifth data field value comprises a virtual desktop a parameter field that is configured to be operable for issuing, downloading and/or installing said professional and/or occupational artificial intelligence (AI) networked virtual operating environment;
receiving, via said first through fifth data fields, an AI networked virtual operating environment that is preconfigured to be customized at least based upon said registration request data fields;
registering and connecting said client virtual operating environment to a specific-global network; and
providing specific tools and/or connecting to database records corresponding to said request for said professional and/or occupational artificial intelligence AI based networked virtual operating environment.

11. The method of claim 10, wherein said professional and/or occupational AI based virtual operating environment comprises at least one of, a virtual desktop, an operating system, and a mobile application; and
wherein said subcategory specialist further comprises at least an oral surgeon.

12. The method of claim 11, further comprising the steps of:
receiving the request;
validating the received request;
processing the received request; and
loading a daily schedule and user role interface.

13. The method of claim 12, further comprising the steps of:
analyzing procedure;
predicting supply usage;
tracking procedure performance; and
depleting supply inventory.

14. The method of claim 13, further comprising the steps of:
triggering a reorder process when the supply inventory falls below a predetermined threshold; and
billing with prefilled insurance forms.

15. The method of claim 14, further comprising the steps of:
updating at least one of a score and resume;
validating at least one of a compliance and certification credit(s); and
storing the validated compliance and/or certification credit(s).

16. The method of claim 15, further comprising the step of:
calculating institution redistribution; and
sending reports and redistribution to the institution.

17. The method of claim 11, further comprising the steps of:
retrieving a user role stored on a role database (DB) based on an institution identification (ID) and a location and/or a field of practice and a specialization;
arranging personalized icons on an AI VD graphical user interface (GUI) display screen; and
detecting an activation of a supply icon on said AI VD graphical user interface (GUI) of the display screen.

18. The method of claim 17, further comprising the steps of:
contacting a supply vendor in response to the supply icon being activated; and
presenting interactive item recommendations from the supply vendor.

19. The method of claim 18, further comprising the steps of:
selecting one or more items from the recommendations provided by the supply vendor by detecting a click on the item recommended by the supply vendor; and
automatically adding the selected item(s) to a digital cart.

20. The method of claim 19, further comprising the steps of:
determining a number and/or amount of selected items; and
providing a payment for the item(s) on the cart via a payment gateway.

21. A method comprising the steps of:
detecting an industry category;
identifying an occupation within said industry category;
registering said industry category and said occupation;
downloading an artificial intelligence (AI) virtual desktop (VD) app utilizing a virtual desktop action parameter field;
installing said artificial intelligence (AI) virtual desktop (VD) app;
executing said artificial intelligence (AI) virtual desktop (VD) app;
logging in on a graphical user interface (GUI) of said artificial intelligence (AI) virtual desktop (VD) app;
registering to a global network;
said global network comprises a system that brings professional digital trade tools to a user's artificial intelligence (AI) virtual desktop (VD);
presenting one or more interactive item recommendations on a GUI display screen of said artificial intelligence (AI) virtual desktop (VD); and
detecting an activation of said one or more of interactive GUI item recommendations.

22. The method of claim 21, wherein said one or more of said interactive GUI item recommendations comprise “Start My Own Business” icon, and wherein the AI engine may recommend at least one of where to move geographically and a location to open up the business.

23. The method of claim 22, further comprising the steps of:
obtaining a business license upon an activation of said “Start My Own Business” icon; and
obtaining occupational license in response to said step of obtaining a business license.

24. The method of claim 23, further comprising the steps of:
obtaining an insurance in response to said step of obtaining a business license and/or occupational license; and
signing up for utilities.

25. The method of claim 22, further comprising the steps of:
tracking a use of business supplies; and
consolidating personal services or personal items to obtain factory price or lowest service price possible.

26. The method of claim 21, further comprising the steps of:
registering a subcategory specialization; and
creating an individual network based on at least one of said industry category, occupation and subcategory specialization.

27. The method of claim 26, further comprising the steps of processing payment or contract transactions through a payment gateway system.

28. The method of claim 27, further comprising the steps of:
tracking financial transactions; and
charging a processing fee for the transactions.

29. The method of claim 26, further comprising the steps of forming a profession-specific global network that is configured as a private, occupation-centered infrastructure generally exclusive to a industry.

30. The method of claim 29, further comprising the steps of:
compartmentalizing each profession-specific global network into sub-category networks, dedicated to specific roles or specialties within that profession;
wherein said profession-specific global network comprises a global dental network;
wherein said sub-category networks comprises a dentist network, orthodontist network and/or dental assistant network.
